(19) United States
(12) Patent Application Publication
(10) Pub. No.: US 2016/0162241 A1
(43) Pub. Date: Jun. 9, 2016

(54) METHOD AND ELECTRONIC DEVICE FOR CONTROLLING DISPLAY THEREOF

(71) Applicant: SAMSUNG ELECTRONICS CO., LTD., Suwon-si (KR)

(72) Inventors: Jin-Wan AN, Daegu (KR); Jeong-Seob KIM, Daegu (KR); Jang-Hoon LEE, Gumi-si (KR)

(21) Appl. No.: 14/953,981

(22) Filed: Nov. 30, 2015

(30) Foreign Application Priority Data
Dec. 3, 2014 (KR) 10-2014-0172212

(51) Int. Cl. G06F 3/14; G09G 5/00

(52) U.S. Cl. CPC G06F 3/1423; G09G 5/006; G09G 2320/08

(57) ABSTRACT

A method of operating an electronic device may include: an operation of detecting an arrangement state of a main display unit and a sub-display unit; and an operation of controlling display of data that are being displayed on a main display included in the main display unit or a sub-display included in the sub-display unit based on the detected arrangement state.

### CROSS-REFERENCE TO RELATED APPLICATION

This application is based on and claims priority under 35 U.S.C. §119 to Korean Application Serial No. 10-2014-0172212, which was filed in the Korean Intellectual Property Office on Dec. 3, 2014, the content of which is incorporated by reference herein in its entirety.

### TECHNICAL FIELD

Various examples of the disclosure relate to a method for controlling a display of an electronic device and an electronic device thereof.

### BACKGROUND/SUMMARY

According to various examples, an electronic device may include a display. The electronic device may display data included in the electronic device using a graphic interface through a display, and may display various device state information elements of the electronic device. The electronic device may be connected to at least one other electronic device through communication circuitry, and may display data of the electronic device through a display of the other electronic device.

According to various examples, when the electronic device controls data displayed on at least one display included in the electronic device, or controls data displayed on a display of another electronic device connected to the electronic device, a user input may be required.

According to various examples, the electronic device may control an operation of displaying data on a display included in the electronic device or another electronic device by identifying (or determining) folding of the other electronic device through at least one sensor.

An electronic device according to various examples includes: a main display apparatus including a main display; a sub-display apparatus comprising at least one sub-display and functionally connected to the main display; at least one sensor configured to detect an arrangement state of the main display apparatus and the sub-display apparatus; and a processor configured to control display of data displayed on the main display or the sub-display based on the detected arrangement state.

According to various examples, an method of operation of an electronic device includes: detecting an arrangement state of a main display apparatus and a sub-display apparatus; and controlling display of data that are being displayed on a main display included in the main display apparatus or a sub-display included in the sub-display apparatus based on a detected arrangement state.

According to various examples, the electronic device controls data displayed on a display of the electronic device and data displayed on a display of another electronic device based on a folding state of the other electronic device, thereby improving an in-use efficiency of a display.

### BRIEF DESCRIPTION OF THE DRAWINGS

The above and other aspects, features, and advantages of the disclosure will be more apparent from the following detailed description taken in conjunction with the accompanying drawings, in which like reference numerals refer to like elements, and wherein:

FIG. 1 illustrates an example network environment including an electronic device.

FIG. 2 is a block diagram illustrating an example electronic device.

FIG. 3 illustrates an example relationship between a main display and a sub-display in an electronic device.

FIG. 4 is a diagram illustrating example data displayed on a main display and a sub-display.

FIG. 5 is a diagram illustrating example data displayed on a display in an electronic device.

FIG. 6 is a diagram illustrating example data displayed on a display in an electronic device.

FIG. 7 is a diagram illustrating example data displayed on a display in an electronic device.

FIG. 8 is a diagram illustrating example data displayed on a display in an electronic device.

FIG. 9 is a diagram illustrating example data displayed on a display in an electronic device.

FIG. 10 is a diagram illustrating example data displayed on a display in an electronic device.

FIG. 11 is a diagram illustrating example data displayed on a display in an electronic device.

FIG. 12 is a diagram illustrating example data displayed on a display in an electronic device.

FIG. 13 is a diagram illustrating example data displayed on a display in an electronic device.

FIG. 14 is a flowchart illustrating an example operation in which data are displayed on a display in an electronic device.

FIG. 15 is a flowchart illustrating an example operation in which data are displayed on a display in an electronic device.

FIG. 16 is a flowchart illustrating an example operation in which data are displayed on a display in an electronic device.

FIG. 17 is a flowchart illustrating an example operation in which data are displayed on a display in an electronic device.

### DETAILED DESCRIPTION

Various examples of the disclosure will be described with reference to the accompanying drawings.

The disclosure may include various examples, and modifications and changes may be made therein. Therefore, the disclosure will be described in detail with reference to particular examples shown in the accompanying drawings. However, it should be understood that the disclosure is not limited to the particular examples, but includes all modifications, equivalents, and/or alternatives within the spirit and scope of the disclosure. In the description of the drawings, similar reference numerals may be used to designate similar elements.

As used in various examples of the disclosure, the expressions “include”, “may include” and other conjugates refer to the existence of a corresponding disclosed function, operation, or constituent element, and do not limit one or more additional functions, operations, or constituent elements. Further, as used in various examples of the disclosure, the terms “include”, “have”, and their conjugates are intended merely to denote a certain feature, numeral, step, operation, element, component, or a combination thereof, and should not be construed to initially exclude the existence of or a possibility of addition of one or more other features, numerals, steps, operations, elements, components, or combinations thereof.

Further, as used in various examples of the disclosure, the expression “or” includes any or all combinations of words enumerated together. For example, the expression “A or B” or “at least A or/and B” may include A, may include B, or may include both A and B.

In the disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, without departing from the scope of the disclosure, a first component element may be named a second component element. Similarly, the second component element also may be named the first component element.

When an element is referred to as being “coupled” or “connected” to any other element, it should be understood that not only the element may be coupled or connected directly to the other element, but also a third element may be interposed therebetween. On the other hand, when an element is referred to as being “directly coupled” or “directly connected” to any other element, it should be understood that no element is interposed therebetween.

The terms as used in various examples of the disclosure are used merely to describe a certain example and are not intended to limit the disclosure. As used herein, singular forms may include plural forms as well unless the context explicitly indicates otherwise. Furthermore, all terms used herein, including technical and scientific terms, have the same meaning as commonly understood by those of skill in the art to which the disclosure pertains. Such terms as those defined in a generally used dictionary are to be interpreted to have the meanings equal to the contextual meanings in the relevant field of art, and are not to be interpreted to have ideal or excessively formal meanings unless clearly defined in various examples of the disclosure.

An electronic device or apparatus according to various examples of the disclosure may be a device or apparatus including a display. The electronic device according to various examples of the disclosure may, for example, include at least one of a smart phone, a tablet personal compute r(PC), a mobile phone, a video phone, an e-book reader, a desktop PC, a laptop PC, a netbook computer, a personal digital assistant (PDA), a portable multimedia player (PMP), an MP3 player, a mobile medical device, a camera, a wearable device (e.g., a head-mount-device (HMD) such as electronic glasses, electronic clothing, an electronic bracelet, an electronic necklace, an electronic appcessory, an electronic tattoo, or a smart watch), a television, a digital video disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an artificial intelligence robot, a Television (TV), an electronic dictionary, an electronic key, a camcorder, medical equipment (e.g., a magnetic resonance angiography (MRA) machine, a magnetic resonance imaging (MRI) machine, a computed tomography (CT) scanner, or an ultrasonic machine), a navigation device, a global positioning system (GPS) receiver, an event data recorder (EDR), a flight data recorder (FDR), a vehicle infotainment device, electronic equipment for a ship (e.g., ship navigation equipment and a gyrocompass), avionics, security equipment, an industrial or home robot, a part of furniture or building/structure, an electronic board, an electronic signature receiving device, a projector, and various measuring instruments (e.g., a water meter, an electricity meter, a gas meter, or a wave meter), each of which includes An electronic device according to examples of the disclosure may be a device including a communication function. The electronic device according to various examples of the disclosure may be a combination of one or more of the aforementioned various devices. Further, the electronic device according to various examples of the disclosure may be a flexible device. Further, it will be apparent to those skilled in the art that the electronic device according to various examples of the disclosure is not limited to the aforementioned devices.

Hereinafter, an electronic device or apparatus according to various examples of the disclosure will be described with reference to the accompanying drawings. The term “user” as used in various examples of the disclosure may indicate a person who uses an electronic device or a device (e.g., artificial intelligence electronic device) that uses an electronic device.

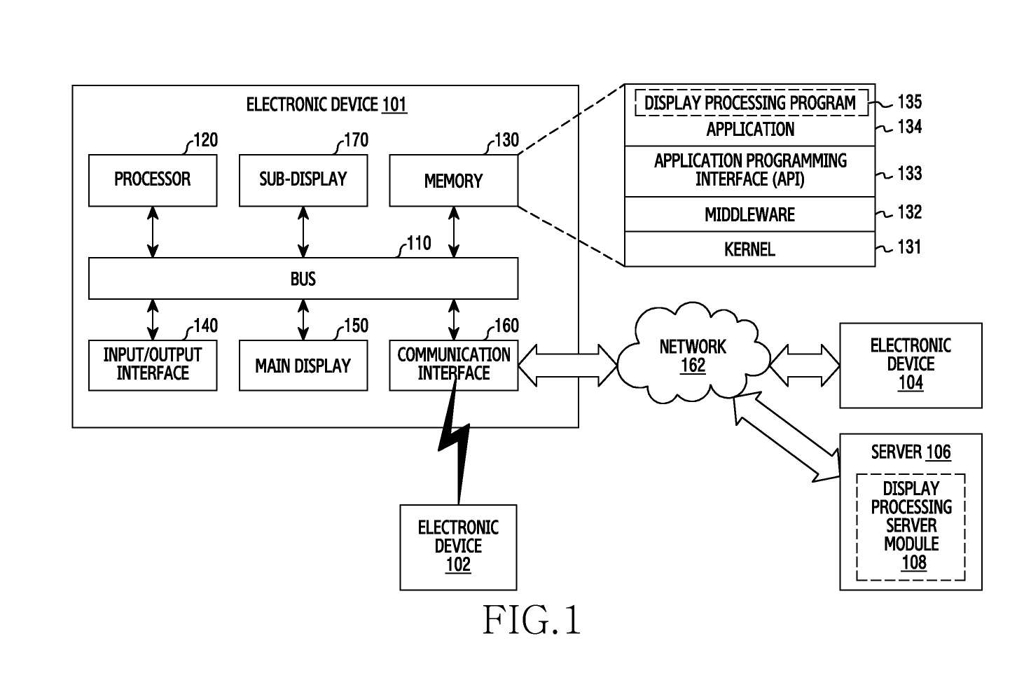

FIG. 1 illustrates an example network environment including an electronic device or apparatus.

Referring to FIG. 1, the electronic device 101 may include at least one of a bus 110, a processor 120, a memory 130, an input/output interface 140, a display 150, e.g., a main display, a sub-display 170, and a communication interface 160.

The bus 110 may be a circuit that connects the aforementioned elements to each other and transmits communication signals (e.g., control messages) between the aforementioned elements.

The processor 120 may, for example, receive commands from the above-mentioned other elements (e.g., the memory 130, the input/output interface 140, the display 150, and the communication interface 160) via the bus 110, interpret the received commands, and perform calculations or data processing based on the interpreted commands.

The processor 120 may be included in the electronic device 101 to perform a predetermined function of the electronic device 101. According to an example, the processor 120 may include one or more Application Processors (APs) and one or more Micro Controller Units (MCUs). According to another example, the processor 120 may include one or more micro controller units as applications, or may be functionally connected to one or more micro controller units. In FIG. 1, the APs and the MCUs may be included in one IC package, or may be separately configured to be included in different IC packages, respectively. According to an example, the MCUs may be included in an IC package of the APs to be configured as one IC package together with the APs. Although the processor 120 includes the APs or the MCUs, it is only an example provided for clear understanding, and it will be apparent that the processor 120 may also perform operations of the APs and/or the MCUs.

The APs may drive an operating system or an application program (or an application) to control a plurality of hardware or software elements connected thereto, and may process various types of data including multimedia data and perform calculations. The APs may be implemented by, for example, a System on Chip (SoC). According to an example, the processor 120 may further include a Graphic Processing Unit (GPU) (not illustrated).

The MCUs may, for example, be processors configured to perform a predetermined operation. According to an example, the MCU may acquire sensing information through one or more specified motion or other sensors (for example, gyro sensor, acceleration sensor, or geomagnetic sensor), compare the acquired sensing information, and determine the operational state of the specified motion sensors with reference to a database of the electronic device 101.

According to an example, the AP or the MCU may load a command or data received from at least one of a non-volatile memory or other components connected to each of the AP and the MCU in a volatile memory, and may process the loaded command or data. Furthermore, the APs or the MCUs may store data received from or generated by at least one of the other elements in a non-volatile memory.

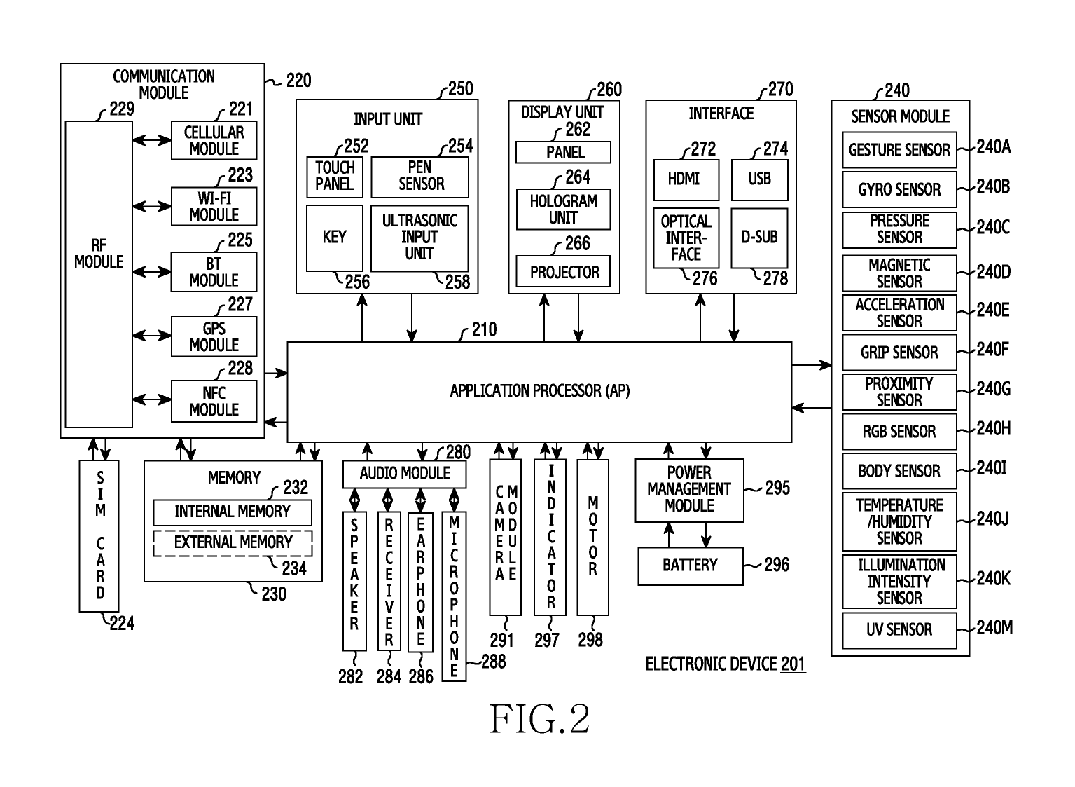

The memory 130 (for example, the memory 230 of FIG. 2) may store commands or data received from the processor 120 or other component elements (for example, the input/output interface 140, the display 150, and the communication interface 160) or generated by the processor 120 or other elements. The memory 130 may, for example, include programming modules, for example, a kernel 131, middleware 132, an application programming interface (API) 133, an application 134, and the like. Each of the programming modules may be formed of software, firmware, or hardware, or a combination of two or more thereof.

The kernel 131 may, for example, control or manage the system resources (e.g., the bus 110, the processor 120, and the memory 130) used to execute operations or functions implemented in the remaining programming modules, for example, the middleware 132, the API 133, and the applications 134. Also, the kernel 131 may provide an interface to the middleware 132, the API 133, or the application 134, so as to access each component element of the electronic device 101 for control or management.

The middleware 132 may, for example, act as an intermediary so as to allow the API 133 or the application 134 to communicate with and exchange data with the kernel 131. Further, for operation requests received from the application 134, the middleware 132 may control the operation requests (for example, perform scheduling or load balancing) by using, for example, a method of prioritizing at least one of the applications 134 in using system resources (for example, the bus 110, the processor 120, the memory 130, or the like) of the electronic device 101.

The API 133 is, for example, an interface used by the application 134 to control a function provided from the kernel 131 or the middleware 132, and may include, for example, at least one interface or function (for example, an instruction) for a file control, a window control, image processing, a character control, or the like.

The applications (or processors) 134 may include a short message service (SMS)/multimedia message service (MMS) application, an e-mail application, a calendar application, an alarm application, a health care application (e.g., application for monitoring physical activity or blood glucose), and an environmental information application (e.g., application for providing atmospheric pressure, humidity, or temperature information). The applications (or processors) 134 may correspond to an application associated with information exchange between the electronic device 101 and an external electronic device (e.g., the electronic device 102 or the electronic device 104). The application associated with information exchange may include, for example, a notification relay application for forwarding specific information to an external electronic device, or a device management application for managing an external electronic device. The notification relay application may, for example, include a function of transferring, to an external electronic device (e.g., the electronic device 104), notification information generated by other applications (e.g., an SMS/MMS application, an e-mail application, a health management application, or an environmental information application) of the electronic device 101. Additionally or alternatively, the notification relay application may receive notification information from, for example, the external electronic device (e.g., the electronic device 104) and provide the received notification information to a user. For example, the device management application may manage (e.g., install, delete, or update) functions for at least a part of the external electronic device (e.g., the electronic device 104) communicating with the electronic device 101 (e.g., turning on/off the external electronic device itself (or some elements thereof) or adjusting brightness (or resolution) of a display), applications operating in the external electronic device, or services (e.g., a telephone call service or a message service) provided from the external electronic device. According to various examples, the applications 134 may include an application designated according to the attribute (e.g., the type) of the external electronic device (e.g., the electronic device 102 or 104). For example, when the external electronic device is an MP3 player, the application 134 may include an application related to the reproduction of music. Similarly, in the case where the external electronic device is a mobile medical appliance, the application 134 may include an application related to health care. According to an example, the applications 134 may include at least one of an application designated to the electronic device 101 and an application received from the external electronic device (e.g., a server 106 or the electronic device 104). A display processing program 135 may be provided in the application 134, or may be stored in the memory 130 as a separate program.

The display processing program 135 may determine an arrangement state of a sub-display unit or apparatus, and control a display location of at least one of data displayed on a main display of the electronic device and data displayed on the sub-display unit or apparatus based on the arrangement state. The display processing program 135 may determine an arrangement state of the sub-display unit. The display processing program 135 may determine an arrangement state of the sub-display unit using at least one of, for example, a proximity sensor, an infrared ray sensor, an illumination intensity sensor, and a magnetic sensor connected to the sub-display (for example, a hall sensor or a Hall IC) included in the electronic device. The display processing program 135 may display data displayed on a display of the sub-display unit on the main display. The display processing program 135 may display data displayed on the main display and the sub-display (for example, a first sub-display) of the electronic device on a second sub-display. The display processing program 135 may determine that the sub-display unit is separated when determining the arrangement state of the sub-display unit. The display processing program 135 may determine that a wired communication, to which the main display unit and the sub-display unit are connected, is connection-released when determining an arrangement state of the sub-display unit. When the wired communication, to which the main display and the sub-display unit are connected, is connection-released, the display processing program 135 may connect the main display unit and the sub-display unit through a short-range wireless communication. The display processing program 135 may identify at least one battery state information element of battery state information of the main display unit and battery state information of the sub-display unit, and control a display location of at least one of the display data when the at least one battery state information element satisfies a reference condition.

The input/output interface 140 may transfer instructions or data, input, for example, by a user through an input/output device (e.g., various sensors, such as an acceleration sensor or a gyro sensor, and/or a device such as a keyboard or a touch screen), to the processor 120, the memory 130, or the communication interface 160 through the bus 110. For example, the input/output interface 140 may provide the processor 120 with data on a touch input through a touch screen. Furthermore, the input/output interface 140 may output instructions or data, received from, for example, the processor 120, the memory 130, or the communication interface 160 via the bus 110, through an output unit (e.g., a speaker or the display 150). For example, the input/output interface 140 may output voice data processed by the processor 120 through a speaker.

The display may display various pieces of information (e.g., multimedia data or text data). The display may include a touch screen for inputting a command while an input unit touches or approach-touches the display.

In various examples, the electronic device 101 may include two or more displays. When two or more displays are included in the electronic device 101, they may be classified into a main display 150 and a sub-display (auxiliary display) 170. The electronic device 101 may be classified into a main display unit or apparatus including the main display and a sub-display unit including the sub-display (auxiliary display) 170. The main display unit or apparatus of the electronic device 101 may further include at least one display without being limited to include the main display 150. For example, the electronic device 101 may include the main display 150, and two or more sub-displays (for example, a main display and a second display). When the electronic device 101 includes the displays in the main display unit and the sub-display unit, the main display unit may include the main display 150 and the sub-display unit may include the first sub-display. When the electronic device 10 includes a second sub-display, the second sub-display may be included in the main display unit or the sub-display unit.

According to various examples, at least one sub-display included in the sub-display unit of the electronic device 101 may display a graphic interface through control of a processor 120, or may receive power for an operation of the sub-display (for example, display of a graphic interface) from a battery (for example, a battery included in the main display unit and/or the sub-display unit) included in the electronic device 101.

The communication interface 160 (for example, a communication module 220 in FIG. 2) may establish a communication connection between the electronic device 101 and an external device (for example, the electronic device 104 or the server 106). For example, the communication interface 160 may be connected to a network 162 through wireless or wired communication to communicate with the external device. The wireless communication may include, for example, at least one of Wi-Fi, Bluetooth (BT), near field communication (NFC), global positioning system (GPS), and cellular communication (for example, LTE, LTE-A, CDMA, WCDMA, UMTS, WiBro, GSM or the like). The wired communication may include, for example, at least one of a universal serial bus (USB), a high definition multimedia interface (HDMI), recommended standard 232 (RS-232), and a plain old telephone service (POTS).

According to an example, the network 162 may be a communication network. The communication network may include at least one of a computer network, the Internet, the Internet of Things, and a telephone network. According to an example of the disclosure, at least one of the application 134, the application programming interface 133, the middleware 132, the kernel 131, and the communication interface 160 may support a protocol (for example, transport layer protocol, data link layer protocol, or physical layer protocol) for communication between the electronic device 101 and an external device.

According to an example, a server 106 may support the driving of the electronic device 101 by performing at least one of the operations (or functions) implemented by the electronic device 101. For example, the server 106 may include the processor 120 that controls the electronic device 101 to perform various examples of the disclosure to be described below or a server module (e.g., a server controller or a server processor, not illustrated) that may support a particular module designated to perform the various examples. For example, the server module may include at least one element of the processor 120 or a specific module to perform at least one operation of the operations performed by the processor 120 or the specific module (for example, perform the operation on behalf of the processor 120 or the specific module). According to various examples, the server module may be a display processing server module 108 of FIG. 1.

Additional information on the electronic device 101 will be provided through FIGS. 2 to 17 below.

FIG. 2 is a block diagram illustrating an example electronic device or apparatus.

The electronic device 201 may include, for example, the entirety or a part of the electronic device 101 illustrated in FIG. 1, or may expand all or some elements of the electronic device 101. Referring to FIG. 2, the electronic device 201 may include at least one processor 210, a communication module including communication circuitry 220, a Subscriber Identification Module (SIM) card 224, a memory 230, a sensor module including at least one sensor 240, an input device including input circuitry 250, a display unit including at least one display 260, an interface 270, an audio module 280, a camera module 291, a power management module 295, a battery 296, an indicator 297, or a motor 298.

The processor 210 may be included in the electronic device 101 to perform a predetermined function of the electronic device 101. According to an example, the processor 210 may include one or more Application Processors (APs) and one or more Micro Controller Units (MCUs). According to another example, the processor 210 may include one or more micro controller units as applications, or may be functionally connected to one or more micro controller units. In FIG. 1, the APs and the MCUs may be included in one IC package, or may be separately configured to be included in different IC packages, respectively. According to an example, the MCUs may be included in an IC package of the APs to be configured as one IC package together with the APs. Although the processor 210 includes the APs or the MCUs, it is only an example provided for clear understanding, and it is apparent that the processor 210 may also perform operations of the APs and/or the MCUs.

The APs may drive an operating system or an application program to control a plurality of hardware or software elements connected thereto, and may process various types of data including multimedia data and perform calculations. The APs may be implemented by, for example, a System on Chip (SoC). According to an example, the processor 210 may further include a Graphic Processing Unit (GPU) (not illustrated).

The MCUs may be processors configured to perform a predetermined operation. According to an example, the MCUs may acquire sensing information through one or more specified motion sensors (e.g., a gyro sensor 240B, an acceleration sensor 240E, or a geomagnetic sensor (not illustrated)), compare the acquired sensing information, and determine the operating state of the specified sensor (e.g., the geomagnetic sensor) by making reference to a database of the electronic device 101. In addition, although the MCUs and the elements of the sensor module 240 are illustrated as separate elements in FIG. 2, the MCUs may be implemented to include at least some of the elements of the sensor module 240 (e.g., at least one of the gyro sensor 240B, the acceleration sensor 240E, and the geomagnetic sensor).

According to an example, the AP or the MCU may load a command or data received from at least one of a non-volatile memory or other components connected to each of the AP and the MCU in a volatile memory, and may process the loaded command or data. Furthermore, the APs or the MCUs may store data received from or generated by at least one of the other elements in a non-volatile memory.

The communication module 220 (e.g., the communication interface 160) includes various communication circuitry and may perform data transmission/reception in communication between the electronic device 101 and the other electronic devices (e.g., the electronic device 102 or 104, or the server 106) connected thereto through a network. According to an example, the communication module 220 may include a cellular module 221, a Wi-Fi module 223, a BT module 225, a GPS module 227, an NFC module 228, and a Radio Frequency (RF) module 229.

The cellular module 221 may provide a voice call service, a video call service, a text message service, or an Internet service through a communication network (e.g., Long Term Evolution (LTE), LTE-A, Code Division Multiple Access (CDMA), Wideband CDMA (WCDMA), Universal Mobile Telecommunication System (UMTS), Wireless Broadband (WiBro), or Global System for Mobile communication (GSM)). Furthermore, the cellular module 221 may distinguish between and authenticate electronic devices within a communication network using, for example, a subscriber identification module (e.g., the SIM card 224). According to an example, the cellular module 221 may perform at least some of the functions that the AP 210 may provide. For example, the cellular module 221 may perform at least some of the multimedia control functions.

According to an example of the disclosure, the cellular module 221 may include a Communication Processor (CP). Furthermore, the cellular module 221 may be implemented by, for example, an SoC. Although the elements such as the cellular module 221 (e.g., a communication processor), the memory 230, and the power management module 295 are illustrated to be separate from the AP 210 in FIG. 2, the AP 210 may include at least some of the aforementioned elements (e.g., the cellular module 221) according to an example.

According to an example, the AP 210 or the cellular module 221 (e.g., the communication processor) may load instructions or data, received from a non-volatile memory or at least one of the other elements connected thereto, to a volatile memory and process the loaded instructions or data. Furthermore, the AP 210 or the cellular module 221 may store data received from or generated by at least one of the other elements in a non-volatile memory.

The Wi-Fi module 223, the BT module 225, the GPS module 227, and the NFC module 228 may include a processor for processing data transmitted/received through the corresponding module. In FIG. 2, the cellular module 221, the Wi-Fi module 223, the BT module 225, the GPS module 227, and the NFC module 228 are illustrated as separate blocks. However, according to an example, at least some (e.g., two or more) of the cellular module 221, the Wi-Fi module 223, the BT module 225, the GPS module 227, and the NFC module 228 may be included in one Integrated Chip (IC) or one IC package. For example, at least some (for example, the communication processor corresponding to the cellular module 221 and the Wi-Fi processor corresponding to the Wi-Fi module 223) of the processors corresponding to the cellular module 225, the Wi-Fi module 227, the BT module 228, the GPS module 227, and the NFC module 228 may be implemented as one SoC.

The RF module 229 may transmit/receive data, for example, RF signals. Although not illustrated in the drawing, the RF module 229 may, for example, include a transceiver, a Power Amp Module (PAM), a frequency filter, a Low Noise Amplifier (LNA), or the like. In addition, the RF module 229 may further include an element for transmitting/receiving electronic waves over free air space in wireless communication, for example, a conductor, a conducting wire, or the like. In FIG. 2, the cellular module 221, the Wi-Fi module 223, the BT module 225, the GPS module 227, and the NFC module 228 share one RF module 229. However, according to an example, at least one of them may transmit/receive an RF signal through a separate RF module.

The SIM card 224 may be a card including a subscriber identification module, and may be inserted into a slot formed in a predetermined location of the electronic device. The SIM card 224 may include unique identification information (e.g., an integrated circuit card identifier (ICCID)) or subscriber information (e.g., an international mobile subscriber identity (IMSI)).

The memory 230 (e.g., the memory 130) may include an internal memory 232 or an external memory 234. The internal memory 232 may include at least one of a volatile memory (e.g., a Dynamic Random Access Memory (DRAM), a Static RAM (SRAM), a Synchronous Dynamic RAM (SDRAM), or the like) or a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, or the like).

According to an example, the internal memory 232 may be a Solid State Drive (SSD). The external memory 234 may further include a flash drive, for example, a compact flash (CF), a secure digital (SD), a micro secure digital (Micro-SD), a mini secure digital (Mini-SD), an extreme digital (xD), a Memory Stick, or the like. The external memory 234 may be functionally connected to the electronic device 201 through various interfaces. According to an example, the electronic device 201 may further include a storage device (or storage medium) such as a hard disc drive.

The sensor module 240 may measure a physical quantity or sense an operating state of the electronic device 201, and may convert the measured or sensed information into an electric or electronic signal. The sensor module 240 may include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., red, green, and blue (RGB) sensor), a biometric sensor 2401, a temperature/humidity sensor 240J, an illumination sensor 240K, and a Ultra Violet (UV) sensor 240M. Additionally or alternatively, the sensor module 240 may, for example, include an E-nose sensor (not shown), an electromyography (EMG) sensor (not shown), an electroencephalogram (EEG) sensor (not shown), an electrocardiogram (ECG) sensor (not shown), an Infrared (IR) sensor (not shown), an iris sensor (not shown), a fingerprint sensor (not shown), and the like. The sensor module 240 may further include a control circuit for controlling one or more sensors included therein.

The input device 250 may include input circuitry including a touch panel 252, a (digital) pen sensor 254, a key 256, or an ultrasonic input device 258. The touch panel 252 may recognize a touch input in at least one of, for example, a capacitive scheme, a resistive scheme, an infrared scheme, and an ultrasonic wave scheme. The touch panel 252 may further include a control circuit. In a case of the capacitive type touch panel, physical contact or proximity detection is possible. The touch panel 252 may further include a tactile layer. In this case, the touch panel 252 may provide a user with a tactile reaction.

The (digital) pen sensor 254 may be implemented, for example, using the same or a similar method to receiving a user's touch input or using a separate recognition sheet. The key 256 may include, for example, a physical button, an optical key, or a keypad. The ultrasonic input device 258 may identify data by detecting an acoustic wave with a microphone (e.g., a microphone 288) of the electronic device 201 through an input unit generating an ultrasonic signal, and may perform wireless detection. According to an example, the electronic device 201 may also receive a user input from an external device (e.g., a computer or server) connected thereto using the communication module 220.

The display 260 (e.g., the display 150) may include a panel 262, a hologram device 264, or a projector 266. The panel 262 may be, for example, a Liquid Crystal Display (LCD), an Active Matrix Organic Light Emitting Diode (AM-OLED), or the like. The panel 262 may be implemented to be, for example, flexible, transparent, or wearable. The panel 262 may be formed as a single module together with the touch panel 252. The hologram device 264 may show a three dimensional image in the air using an interference of light. The projector 266 may display an image by projecting light onto a screen. The screen may be located, for example, in the interior of or on the exterior of the electronic device 201. According to an example, the display 260 may further include a control circuit configured to control the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 160 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert a sound and an electrical signal. At least some elements of the audio module 280 may be included in, for example, the input/output interface 140 illustrated in FIG. 1. The audio module, e.g., codec 280 may process voice information input or output through, for example, a speaker 282, a receiver 284, earphones 286, or the microphone 288. The camera module 291 is a device for capturing still and moving images, and may include one or more image sensors (e.g., a front sensor or a rear sensor), a lens (not illustrated), an image signal processor (ISP, not illustrated), or a flash (e.g., an LED or a xenon lamp, not illustrated) according to an example.

The power management module 295 may manage the power of the electronic device 201. Although not illustrated, the power management module 295 may include, for example, a Power Management Integrated Circuit (PMIC), a charger Integrated Circuit (IC), or a battery or fuel gauge. According to various examples, the PMIC may be mounted to an integrated circuit or an SoC semiconductor. Charging methods may be classified into a wired charging method and a wireless charging method. The charger IC may charge a battery and may prevent an overvoltage or excess current from being induced or flowing from a charger.

According to an example, the charger IC may include a charger IC for at least one of the wired charging and the wireless charging. Examples of the wireless charging may include magnetic resonance charging, magnetic induction charging, and electromagnetic charging, and an additional circuit such as a coil loop, a resonance circuit, and a rectifier may be added for the wireless charging.

The battery gauge may measure, for example, a residual quantity of the battery 296, and a voltage, a current, or a temperature while charging. The battery 296 may store or generate electricity and may supply power to the electronic device 201 using the stored or generated electricity. The battery 296 may include, for example, a rechargeable battery or a solar battery.

The indicator 297 may display a specific state of the electronic device 201 or a part thereof (e.g., the AP 210), for example, a boot-up state, a message state, or a state of charge (SOC). A motor 298 may convert an electrical signal into a mechanical vibration. Although not illustrated, the electronic device 201 may include a processing device (e.g., a GPU) for supporting mobile TV. The processing unit for supporting mobile TV may process, for example, media data pursuant to a certain standard of Digital Multimedia Broadcasting (DMB), Digital Video Broadcasting (DVB), or media flow.

Each of the above described elements of the electronic device according to various examples of the disclosure may include one or more components, and the name of a corresponding element may vary according to the type of electronic device. The electronic device according to various examples of the disclosure may include at least one of the above described elements and may exclude some of the elements or further include other additional elements. Further, some of the elements of the electronic device according to various examples of the disclosure may be coupled to form a single entity while performing the same functions as those of the corresponding elements before the coupling.

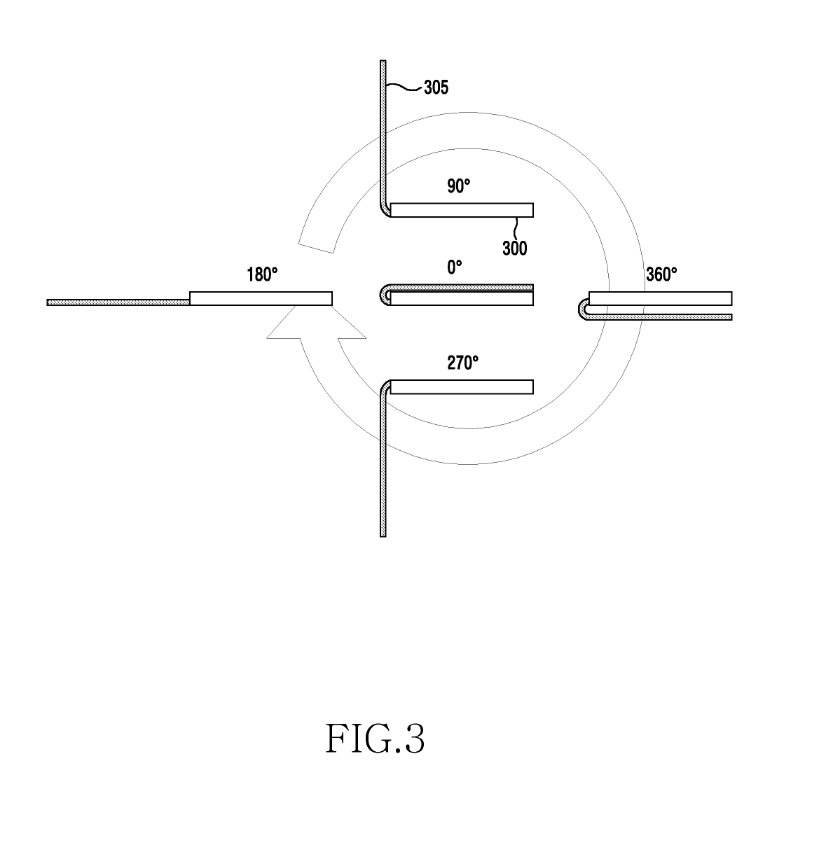

FIG. 3 illustrates an example relationship between a main display and a sub-display in an electronic device.

According to various examples, the electronic device 101 may identify the arrangement state of the main display 150 and the sub-display 170 by changing the location of the main display unit 300 and/or the sub-display unit 305. Here, the arrangement states of the main display unit 300 and/or the sub-display unit 305 may be illustrated by identifying the arrangement states of the main display 150 and the sub-display 170. Here, when the arrangement state of the main display unit 300 and/or the sub-display unit 305 is identified, the arrangement state formed by the main display unit 300 and the sub-display unit 305 together may be identified. With reference to any one of the main display unit 300 and the sub-display unit 305, a state in which the remaining display unit is located may be identified as an arrangement state. In this state, it may be described that the arrangement state of the main display unit 300 or the sub-display unit is identified. Accordingly, the arrangement states of the main display unit 300 and the sub-display unit used in disclosure may be used as the same or similar meaning to the arrangement state of the main display unit 300 or the sub-display unit. Similarly, the arrangement states of the main display 150 and the sub-display 170 may be used as the same or similar meaning to the arrangement state of the main display 150 or the sub-display 170.

Here, the arrangement states of the main display 150 and the sub-display 170 may represent an opened state or a closed state of the sub-display unit 305, or may represent a folded state or an unfolded state of the sub-display unit 305 with reference to the main display unit 300 of the electronic device 101. Here, the closed state may, for example, be a facing closed state in which the arrangement state of the main display unit 300 and the sub-display unit 305 is the same as or similar to 0 degrees (for example, more than 0 degrees and less than 30 degrees), or may be a backing closed state in which the arrangement state of the main display unit 300 and the sub-display unit 305 is the same as or similar to 360 degrees (for example, more than 330 degrees and less than 360 degrees). Here, in various examples illustrated in FIG. 3, various methods of expressing the opened state, the facing closed state, and the backing closed state may be described.

According to an example, when the arrangement state of the main display unit 300 and the sub-display unit 305 is identified, the electronic device 101 may identify the arrangement angle of the main display unit 300 and the sub-display unit 305 (or the main display and the sub-display) as illustrated in FIG. 3. According to an example, the electronic device 101 may identify the arrangement angle of the main display unit 300 and the sub-display unit through sensors included in the main display unit 300 and/or the sub-display unit 305. For example, when an opened state or a closed state is expressed, an angle such as 90 degrees, 180 degrees, 270 degrees, or 360 degrees with reference to 0 degrees may be expressed as an opened state, the electronic device 101 may describe a change of increasing the main display unit 300 and the sub-display unit 305 with reference to 0 degrees as an opening operation, or a change of decreasing the angle as a closing operation.

According to various examples, the electronic device 101 may determine an arrangement state (for example, 180 degrees) in which the angle of the main display unit 300 and the sub-display unit 305 have a designated angle or a designated range as a reference state (for example, an opened state). When the arrangement state in which the angle of the main display unit 300 and the sub-display unit 305 is 180 degrees is determined as a reference state, the electronic device 101 may describe a change of decreasing the angle of the sub-display unit 305 towards 0 degrees with reference to 180 degrees (for example, an opened state) may be described as a facing closing operation or a change of increasing the angle towards 360 degrees as a backing closing operation. Here, the opposite change may be described as an opening operation. For example, when an arrangement state (for example, 180 degrees) in which the angle of the main display unit 300 and the sub-display unit 305 has a designated angle or a designated range is determined as a reference state (for example, an opened state), the electronic device 101 may describe an operation of increasing the angle of the sub-display unit 305 towards 180 degrees in a facing closed state (for example, a state in which the angle of the main display unit 300 and the sub-display unit 305 is more than 0 degrees and less than 30 degrees) as an opening operation or an operation of decreasing the angle of the sub-display unit 305 towards 180 degrees in a backing closed state (for example, a state in which the angle of the main display unit 300 and the sub-display unit 305 is more than 330 degrees and less than 360 degrees) as an opening operation. In addition, the electronic device 101 may describe a state in which the arrangement state of the main display unit 300 and the sub-display unit 305 is the same as or similar to 0 degrees (for example, more than 0 degrees and less than 30 degrees) as a facing closed state and a state in which the arrangement state of the main display unit 300 and the sub-display unit 305 is the same as or similar to 360 degrees (for example, more than 330 degrees and less than 360 degrees) as a backing closed state.

According to an example, when the arrangement state of the main display unit 300 and the sub-display unit 305 is described as a folding state or an unfolding state, the electronic device 101 may determine an arrangement state (for example, 180 degrees) in which the angle of the main display unit 300 and the sub-display unit 305 has a designated angle or a designated range as a reference state (for example, an unfolding state). For example, when the arrangement state in which the angle of the main display unit 300 and the sub-display unit 305 is 180 degrees as a reference state, the electronic device 101 may describe a change of decreasing the angle of the sub-display unit 305 towards 0 degrees with reference to 180 degrees (for example, an unfolding state) as a facing folding operation or a change of increasing the angle towards 360 degrees as a backing folding operation. Here, the opposite change may be described as an unfolding operation. In addition, the electronic device 101 may describe a state in which the arrangement state of the main display unit 300 and the sub-display unit 305 is the same as or similar to 0 degrees (for example, more than 0 degrees and less than 30 degrees) as a facing folded state and a state in which the arrangement state of the main display unit 300 and the sub-display unit 305 is the same as or similar to 360 degrees (for example, more than 330 degrees and less than 360 degrees) as a backing folded state.

According to various examples, when the arrangement state of the main display unit 300 and the sub-display unit 305 is identified, the electronic device 101 may identify it through various sensors. For example, the electronic device 101 may identify the arrangement state of the main display unit 300 and the sub-display unit 305 through at least one sensor included in the main display unit 300, the sub-display unit 305, and/or a connection unit (for example, a hinge unit).

According to an example, the electronic device 101 may include a bending sensor by which the arrangement angle (for example, a bending degree of the connection unit) of the main display unit 300 and the sub-display unit 305 in the connection unit (for example, a hinge unit) of the main display unit 300 and the sub-display unit 305. The electronic device 101 may identify the arrangement angle of the main display unit 300 and the sub-display unit 305 through the bending sensor. For example, when the bending sensor included in the connection unit is a sensor for detecting pressure, the electronic device 101 may determine an arrangement angle of the main display unit 300 and the sub-display unit 305 based on a pressure acquired in the arrangement state of the main display unit 300 and the sub-display unit 305. In addition, the electronic device 101 may determine an opening/closing operation or a folding/unfolding operation of the main display unit 300 and the sub-display unit 305 based on a pressure change of the bending sensor for detecting pressure. Hereinafter, in a description of an opening/closing operation or a folding/unfolding operation, an opening operation, a facing closing operation, or a backing closing operation for changing an arrangement state of the sub-display unit 305 may be described with reference to a designated arrangement state (for example, in which the arrangement angle of the main display unit 300 and the sub-display unit is 180 degrees). In addition, in a description of an opened state or a closed state, an arrangement state of 0 degrees in which the main display 150 of the main display unit 300 and the sub-display 170 of the sub-display unit face each other with reference to the main display unit 300 of the electronic device 101 may be described as a facing closed state. Similarly, an arrangement state of 360 degrees in which the main display 150 of the main display unit 300 and the sub-display 170 of the sub-display unit are back-to-back each with other with reference to the main display unit 300 of the electronic device 101 may be described as a backing closed state. Similarly, a state in which the arrangement state of the sub-display 305 is changed to 180 degrees from a closed state (for example, a facing close state or a backing closed state) may be described as an opening operation. In a description of an opened state of the sub-display, the electronic device 101 may describe an acute angle opened state as an opened state of more than 0 degrees and less than 90 degrees, and an obtuse angle opened state of more than 90 degrees and less than 180 degrees, and an opened state of more than 180 degrees and less than 360 degrees as an major angle opened state.

According to various examples, the electronic device 101 may include at least one Hall sensor (for example, a Hall IC) in the main display unit 300 and/or the sub-display unit 305. When Hall sensors are included in the main display unit 300, the electronic device 101 may include the Hall sensors on a front surface of the main display unit 300 and a rear surface of the main display unit 300 and the sub-display may include at least one magnetic body. The electronic device 101 may identify the intensity of a magnetic field according to the arrangement state of the sub-display unit through a Hall sensor included in the main display unit 300, and when the sub-display unit is in a facing closed state based on the intensity of a magnetic field of the sub-display unit 305, which is acquired with reference to the main display unit 300, the electronic device 101 may identify a backing closed state or an opened state.

In the following description of an opening/closing operation and a folding/unfolding operation, an opening operation may represent an operation of opening the sub-display unit towards a direction that is 180 degrees with respect to the main display unit 300 in a state in which the sub-display unit is closed (for example, a facing closed state or a backing closed state) or in a state in which the arrangement state of the main display unit 300 and the sub-display unit has a specific angle. In addition, a folding operation may represent an operation of closing the sub-display unit towards a direction that is 0 degrees or 360 degrees with respect to the main display unit 300 in a state in which the sub-display is opened (for example, a state in which the arrangement angle of the main display and the sub-display is 180 degrees) or in a state in which the arrangement state of the main display unit 300 and the sub-display unit has a specific angle. For example, an operation of closing the sub-display unit towards 0 degrees may be described as a folding operation when the specific angle is more than 0 degrees and less than 180 degrees (for example, an astute angle or an obtuse angle), and an operation of closing the sub-display unit towards 360 degrees may be described as a folding operation when the specific angle is more than 180 degrees and less than 360 degrees (for example, a major angle). In addition, even when the sub-display unit is in an arrangement state corresponding to a major angle, a state in which the sub-display unit is completely closed as in a facing closed state (for example, 0 degrees) may be described as a folding state or a folding operation. In a description of the arrangement state of the above-described opening/closing and folding/unfolding operation, not only a connection part of the electronic device 101 and the sub-display unit but also a part of the main display unit 300 and/or a part of the sub-display unit may be bent and/or folded. In addition, in a description of the folding/unfolding operation, the bending method and/or the folding method may be expressed using the terms such as a bending operation, or a folding operation. Similarly, the terms such as a spreading operation and an unfolding operation may be used.

In addition, in a description of the arrangement of the electronic device 101, an arrangement state of the main display unit 300 and the sub-display unit has been described, but the disclosure is not limited thereto and an arrangement state of the main display and the sub-display may be described. In addition, when two sub-displays are provided, an arrangement state of the main display and the first sub-display may be described or an arrangement state of the main display and the second sub-display may be described.

For example, in a description of the arrangement state of the main display 150 and the sub-display 170, the opened state or the closed state of the sub-display unit 305 has been described with reference to the main display unit 300 of the electronic device 101, but the disclosure is not limited thereto and it is noted that the opened state or the closed state of the main display unit 300 may be described with reference to the sub-display unit 305.

In the following description, according to various examples, in the method of displaying data on the main display 150 or the sub-display 170 of the electronic device, a method of displaying data according to an arrangement state such as an opened state, a facing closed state, or a backing closed state of the main display unit 300 and/or the sub-display unit may be described. In addition, the arrangement state is not limited to a shape corresponding to an opened state, a facing closed state, or a backing closed state of the main display unit 300 and/or the sub-display unit, but may be applied to a case in which the main display unit 300 and the sub-display unit 305 are independent display units that are separated from each other. In this case, it is apparent that the arrangement state of the main display unit 300 and/or the sub-display unit may be applied to a state in which the main display and/or the sub-display is switched on, a state in which the main display and/or the sub-display is activated (for example, non-sleep) in a specific mode (for example, a sleep mode) or an opposite case (for example, an off state or a sleep state).

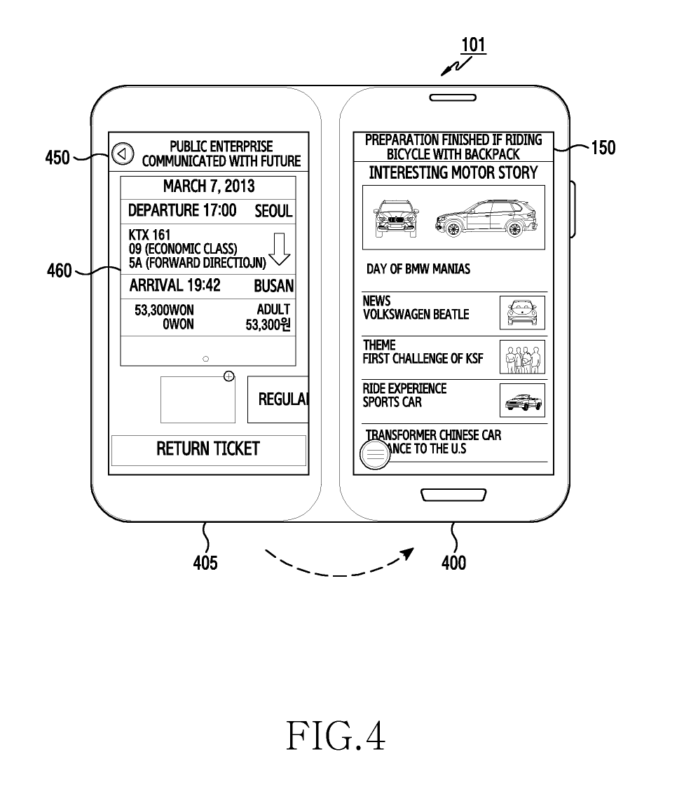

FIG. 4 is a diagram illustrating example data displayed on a main display and a sub-display.

According to various examples, the main display unit 400 and the main display 150 may be connected to a display 450 of the sub-display unit 405 including at least one display. When data are displayed on the display 150 of the main display unit 400, the electronic device 101 may display them through the main display 150 and/or the display 450 of the sub-display unit 405. When data are displayed on the display, the electronic device 101 may control the data displayed on the main display 150 and the display 450 of the electronic device 101 based on setting information. According to an example, the electronic device 101 may display data called based on a user input while data of a specific program (for example, an Internet page) through the main display 150 through the display 450. For example, when a user input that calls an Internet page for identifying ticketing of a ticket of a train (for example, KTX) is detected, the electronic device 101 may control the displays such that an Internet page for identifying ticketing of a ticket of the train may be controlled on the display 450 while data of the program displayed on the main display 150 of the electronic device 101 are maintained. When an Internet page for identifying ticketing of a ticket of a train is displayed on the sub-display 450, the processor 120 may be configured to control the electronic device 101 to display an internet page for identifying ticketing of a ticket of a train on the sub-display 450 through an auxiliary processor when the sub-display unit 405 includes a separate controller (for example, an auxiliary processor and a coprocessor).

In various examples, the electronic device 101 may display data displayed on the display 450 on the main display 150. In an example, when an opening/closing operation of the display 450 of the sub-display unit 405, an off operation, a release operation of a connection of a communication connected to the sub-display unit 405 (when the main display unit 400 and the sub-display unit 405 of the electronic device 101 are detachable) are identified, the electronic device 101 may display the data displayed on the display 450 of the sub-display unit 405 on the main display 150.

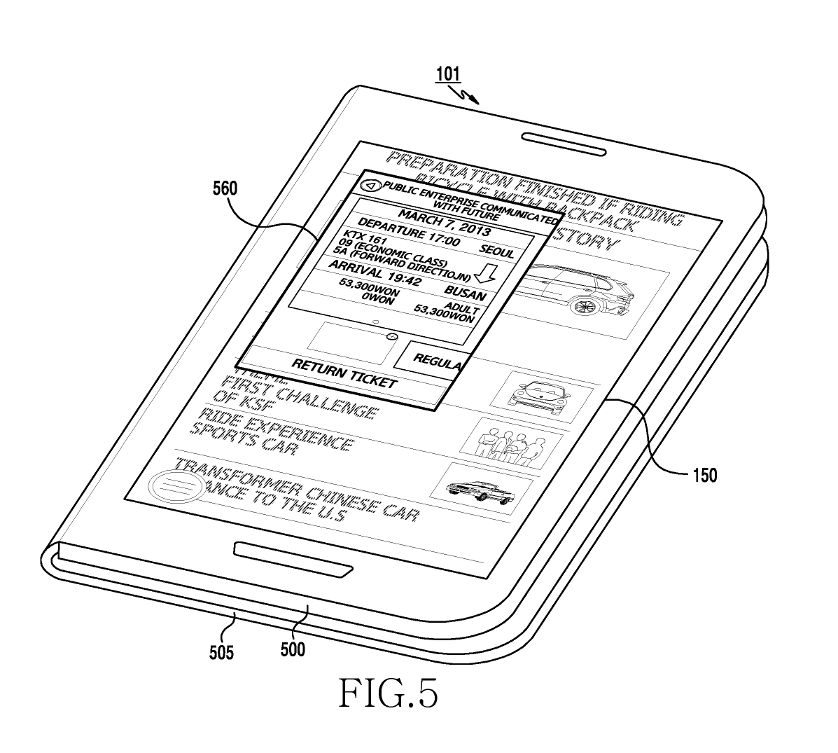

FIG. 5 is a diagram illustrating example data displayed on a display in an electronic device.

According to various examples, the electronic device 101 may control the data displayed on the main display 150 of the main display unit 500 (for example, the data displayed on the sub-display is displayed on the main display 150) based on an opening/closing operation (and/or an arrangement state) of the sub-display unit 505. According to an example, the electronic device 101 may identify a folding operation of the sub-display unit 505. For example, the electronic device 101 may identify that the attached sub-display unit 505 is folded and is located on a rear surface of the electronic device 101 (for example, a backing closed state). According to an example, the electronic device 101 may identify that the sub-display unit 505 is closed to a rear surface of the electronic device 101 based on at least one sensor located on a rear surface of the electronic device 101 or based on a magnetic sensor that interworks with the sub-display unit 505. The electronic device 101 may display the data displayed on the sub-display on a part of the main display 150 of the electronic device 101. According to an example, when the data displayed on the sub-display (for example, the display 450 of FIG. 4) are displayed on the main display 150, the electronic device 101 may generate and display a new layer (for example, a popup window 560). When the data displayed on the sub-display are displayed on the main display 150, the electronic device 101 may generate a layer 560 having a designated size based on setting information. In addition, the electronic device 101 may move a location of the layer 560 displayed on the main display 150 based on a user input (for example, a touch and drag). When an Internet page for identifying ticketing of a ticket of a train is displayed on the main display 150 of the electronic device 101, the electronic device 101 may identify that a power source of the sub-display is switched off.

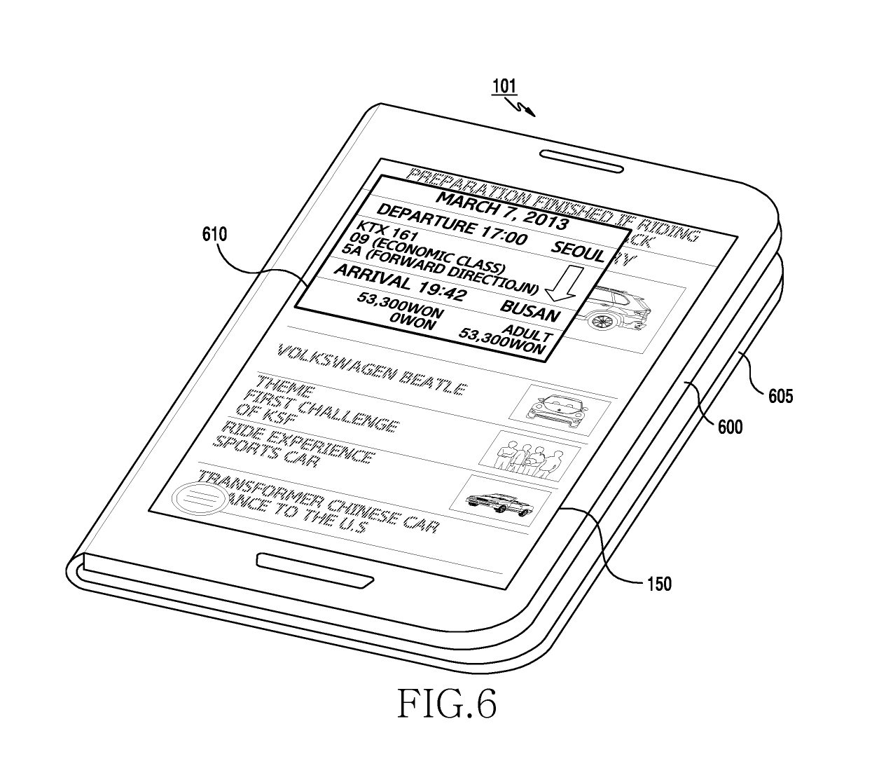

FIG. 6 is a diagram illustrating example data displayed on a display in an electronic device.

According to various examples, when a closing operation of the sub-display unit 605 is identified, the electronic device 101 may display at least some of the data displayed on the sub-display (for example, the display 450 of FIG. 4) on the main display 150 of the main display unit 600. According to an example, the electronic device 101 may identify a closing operation of the sub-display unit 605 while data of a specific program (for example, an internet page for identifying ticketing of a ticket of a train) is displayed on the sub-display. The electronic device 101 may identify that the sub-display unit 605 is folded and is located on a rear surface of the electronic device 101 (for example, a backing closed state). The electronic device 101 may control the device such that a power source of the sub-display may be switched off or identify that the power source of the sub-display is switched off, and identify the data displayed on the sub-display. The electronic device 101 may identify that the data displayed on the sub-display are classified into two or more areas and are displayed. According to an example, the electronic device 101 may identify that the data are classified into a first area displayed on the sub-display (for example, an Internet page area for identifying ticketing of a ticket of a train) and a second area displayed on an Internet page (for example, a ticket area 460 of FIG. 4). The electronic device 101 may identify priorities of the areas (for example, a first area and second area) with reference to setting information (or header information of data), and may determine an area having a high priority (for example, a display area finally displayed as a user input). In addition, when the electronic device 101 determines the priorities, not only the display area finally displayed as a user input is determined to have a high priority but also a priority of an area may be determined using at least one of a display area to which a large number of user inputs are made or an area in which a program that processes a larger amount of data of the processor 120 is displayed. For example, the electronic device 101 may determine a ticket area 460 finally displayed as a user input in an Internet page displayed on the sub-display as an area of a high priority. The electronic device 101 may display the determined ticket area 460 as a designated area of the main display 150. When the ticket area 460 is displayed on the main display 150, the electronic device 101 may generate and display a new layer (for example, a popup window 610). When the ticket area 460 displayed on the sub-display is displayed on the main display 150, the electronic device 101 may generate a layer 610 having a designated size based on setting information. In addition, the electronic device 101 may move a location of the layer 610 displayed on the main display 150 based on a user input (for example, a touch and a drag).

According to various examples, when the electronic device 101 displays a first area and a second area on the sub-display, a first area and a second area may be displayed by separating (or classifying) one layer as described above, or a first area and a second area may be formed of separate layers, respectively to be displayed on the sub-display.

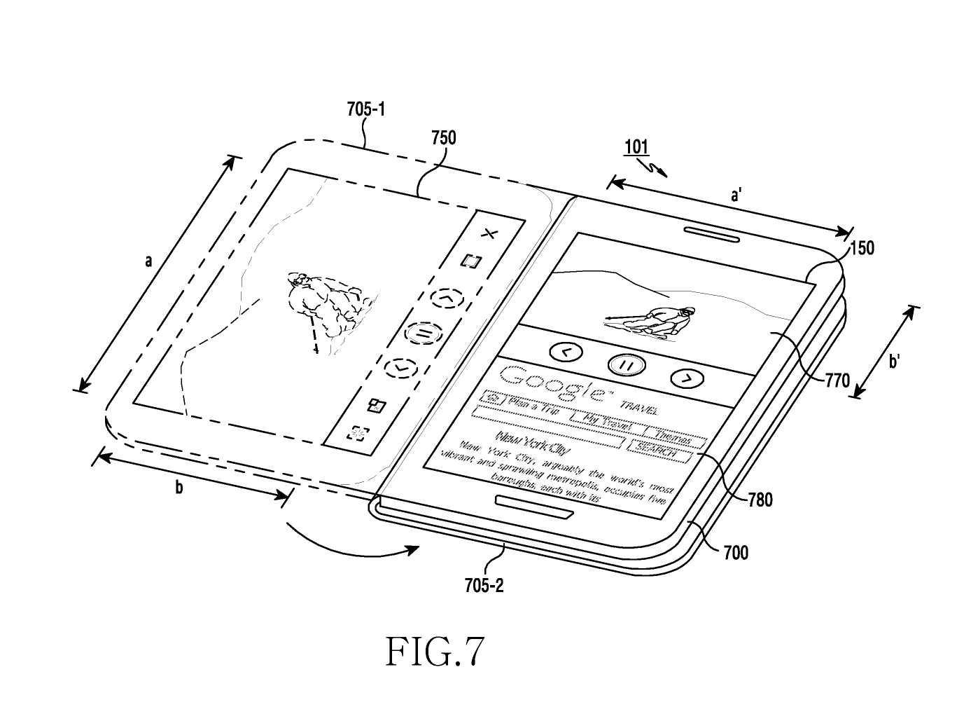

FIG. 7 is a diagram illustrating example data displayed on a display in an electronic device.

According to various examples, the electronic device 101 may display data (a video that is being reproduced) of a specific program displayed on the sub-display 750 of the sub-display unit 705-1 on the main display 150 of the main display unit 700. According to an example, the electronic device 101 may identify a video that is being reproduced on the sub-display 750 in an opened state of a designated angle range (for example, a range of 90 degrees to 180 degrees) as in the arrangement state of the sub-display unit 705-1. When a folding state of the sub-display unit corresponds to a backing closed state located on a rear surface of the electronic device 101 as in the sub-display unit 705-2, the electronic device 101 may perform an operation of displaying a video that is being reproduced on the sub-display 750 on the main display 150. According to an example, when data displayed on the sub-display 750 are displayed on the main display 150 of the electronic device 101, the electronic device 101 may display the data on a part of a layer (for example, a layer that is displaying an Internet page) displayed on the main display 150. For example, the electronic device 101 may determine a first area 770 for data displayed on the sub-display 750 at a part of the main display 150. The electronic device 101 may identify a ratio of a transverse size to a longitudinal size of the data displayed on the sub-display. The electronic device 101 may determine a first area 770 of the same or similar ratio on the main display 150 based on the identified ratio. The electronic device 101 may display data (for example, a video that is being reproduced) of a specific program displayed on the sub-display 750 on the determined first area 770. When the data (for example, a video that is being reproduced) of a specific program displayed on the sub-display 750 are displayed in a first area of the main display 150, the electronic device 101 may display data corresponding to the same size as the data (for example, a video that is being reproduced) of a specific program displayed on the sub-display 750 or display the data after performing an enlarging or contracting operation. The electronic device 101 may display an Internet page that has been displayed in a second area 780 except for the first area of the main display 150.

According to various examples, when the main display 150 is classified into the first area 770 and the second area 780, the electronic device 101 may generate a layer separate from a layer displayed on an Internet page and display data (for example, a video that is being reproduced) of a specific program displayed on the sub-display 750 without limiting the operation to an operation of separating one layer.

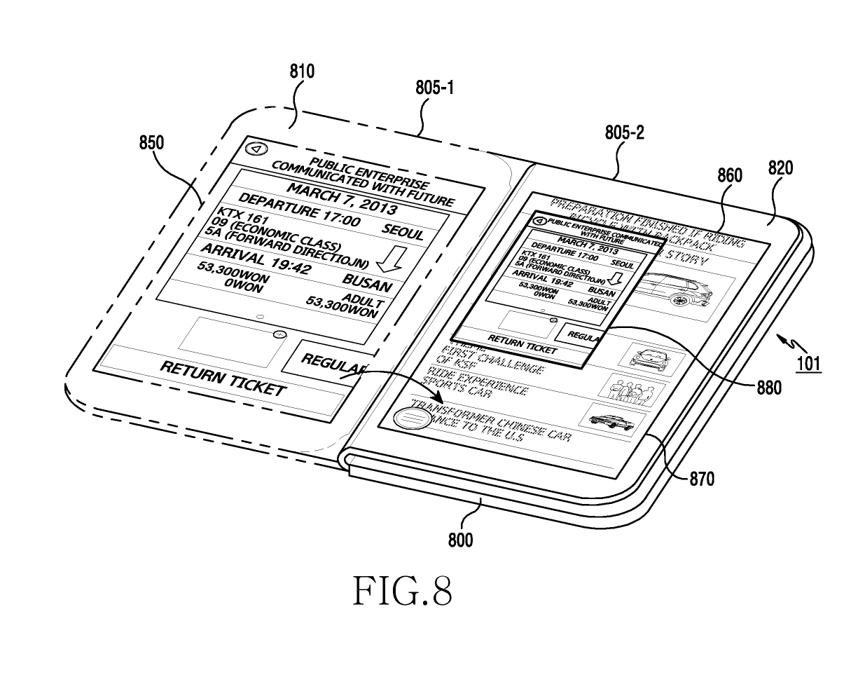

FIG. 8 is a diagram illustrating example data displayed on a display in an electronic device.

According to various examples, when the sub-display unit is folded to a front surface of the electronic device 101 into a facing closed state like the sub-display unit 805-2 while being opened as in the arrangement state of the sub-display unit 805-1, the electronic device 101 may display the data displayed on the main display 150 on the first sub-display (or the second sub-display) of the sub-display unit. According to an example, the electronic device 101 may be in a state in which an Internet page for identifying ticketing of a ticket of a train is displayed on the first sub-display 850 of the sub-display unit, or may be in a state in which an Internet page (for example, see the main display 150 of FIG. 4) related to travels is displayed on the main display 150 of the electronic device 101. The electronic device 101 may identify that the sub-display unit is folded and is located on a front surface of the electronic device 101 where the main display 150 is located. Here, the first sub-display 850 of the sub-display unit may be folded to face the main display 150 of the electronic device 101. The sub-display unit may include two or more displays. For example, the sub-display unit may include a first sub-display 850 on a first surface 810, and may include a second sub-display 860 on a second surface 820. While the first sub-display 850 of the sub-display unit 805-1 is folded to face the display of the electronic device 101, data may be displayed through the second sub-display 860 of the second surface 820 like the sub-display unit 805-2.

According to various examples, when data are displayed on the second sub-display 860, the electronic device 101 may display at least a part of an Internet page that is being displayed on the main display 150 for identifying ticketing of a ticket of a train that is being displayed on the first sub-display 850 on the second sub-display 860. For example, the electronic device 101 may display an Internet page that is being displayed on the main display 150 of the electronic device 101 on an entire screen layer (for example, a layer 870) of the second sub-display 860, and may display an Internet page for identifying ticketing of a ticket of a train that is being displayed on the first sub-display 850 of the sub-display unit on a screen layer (for example, a layer 880) of the second sub-display 860. When data displayed on the second sub-display 860 as a layer 870 are determined, the electronic device 101 may determine that data having a high priority are displayed based on setting information of the electronic device 101. When data of the main display 150 and data of the first sub-display 860 are displayed on the second-sub display 860, the electronic device 101 may not only display the data on two or more layers but also divide and display one layer (for example, see the main display 150 of FIG. 7).

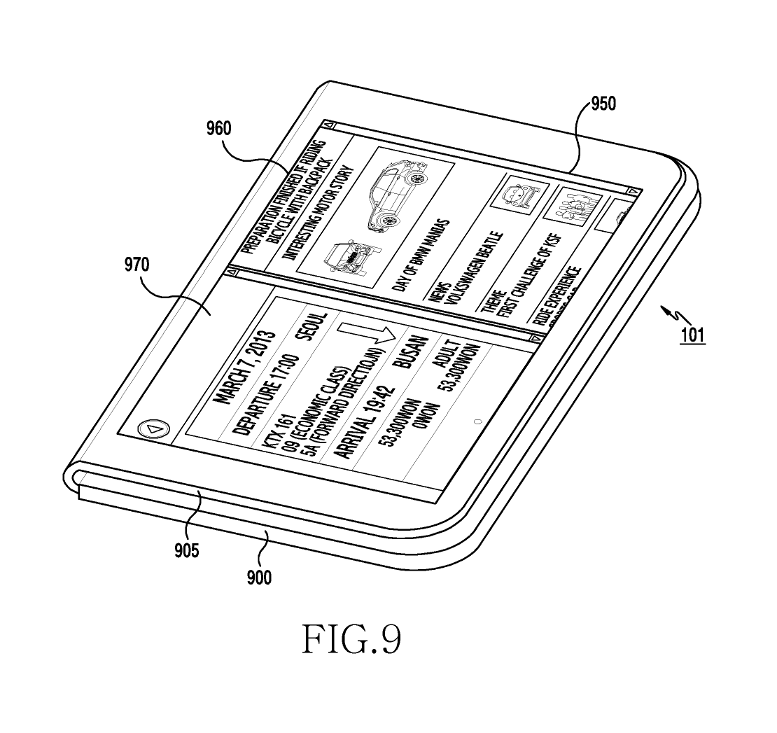

FIG. 9 is a diagram illustrating example data displayed on a display in an electronic device.

According to various examples, the electronic device 101 may determine a method of displaying data on the second sub-display 950 of the sub-display unit 905 based on attribute information of the data displayed on the display. According to an example, the electronic device 101 may identify a screen ratio (for example, a ratio of a transverse size to a longitudinal size) of at least one of data displayed on the main display 150 of the main display unit 900 and/or the first sub-display (for example, the first sub-display 850 of FIG. 8) of the sub-display unit 905. The electronic device 101 may determine a first area for displaying data of the main display 150 and a first area for displaying data of the first sub-display in the second sub-display 950. The electronic device 101 may compare a screen ratio of the first sub-display and/or a screen ratio of the first sub-display with a screen ratio of the first area and/or a screen ratio of the second area. The electronic device 101 may determine a display mode (for example, a landscape mode or a portrait mode) of the second sub-display based on the comparison result. For example, the data displayed on the main display 150 and the first sub-display may be displayed in a portrait mode state. The electronic device 101 may compare the screen ratios of the main display 150 and/or the first sub-display with the screen ratios of the first area and/or the second area, and may determine a mode having the same or similar screen ratio. According to an example, the electronic device 101 may set the second sub-display to a landscape mode when the second sub-display 950 is separated into a first area 960 and a second area 970, and may display data of the main display 150 and data of the first sub-display in the first area 960 and the second area 970 of the portrait mode.

According to an example, the electronic device 101 may identify that the display mode of the main display 150 and the display mode of the first sub-display are different. When the data of the main display 150 and the data of the first sub-display are displayed on the second sub-display 950, the electronic device 101 may determine display priorities of the data of the main display 150 and the data of the first sub-display. The electronic device 101 may determine a display mode (for example, a landscape mode or a portrait mode) of the second sub-display for displaying the data of the main display 150 and the data of the first sub-display based on the display priority determined based on setting information.

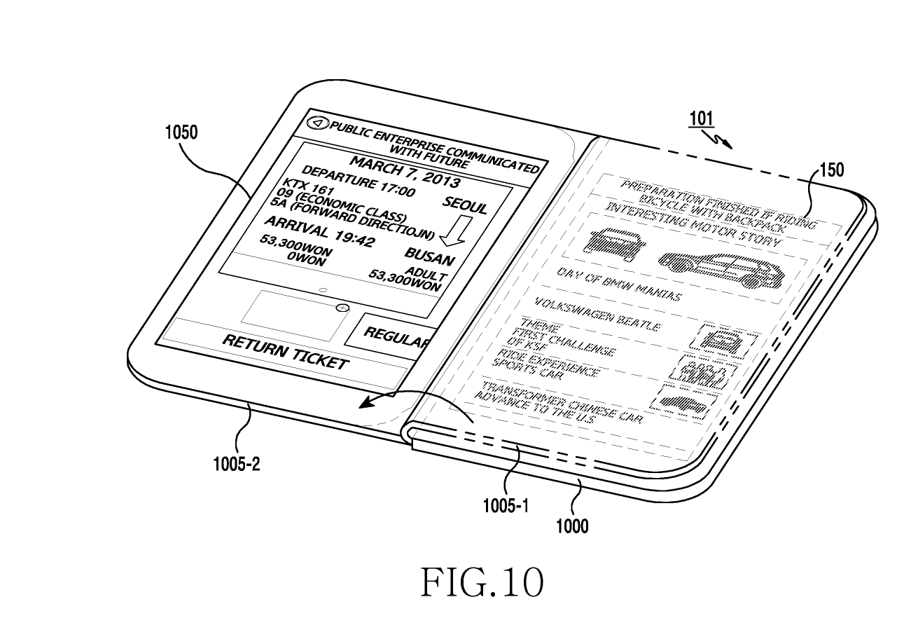

FIG. 10 is a diagram illustrating example data displayed on a display in an electronic device.

According to various examples, the electronic device 101 may display data displayed on one display (for example, the second sub-display of the sub-display unit 1005-1) on two or more displays (for example, the main display 150 of the main display unit 1000 and the first sub-display 1050 of the sub-display unit 1005-2). According to an example, the electronic device 101 may display data in the first area 960 and the second area 970 of the sub-display unit 1005-1 and the second sub-display (for example, see the second sub-display 950 of FIG. 9). The electronic device 101 may identify an unfolding operation of the sub-display unit 1005-1. According to an example, the electronic device 101 may identify an operation of unfolding (or opening) the sub-display unit 1005-1 through at least one sensor (for example, an illumination intensity sensor, an infrared ray sensor, a proximity sensor, and a bending sensor) included on a front surface of the electronic device 101 or a magnetic sensor (for example, a Hall sensor) connected to the sub-display unit 1005-1. When it is identified that the sub-display unit 1005-1 is opened at a designated angle (for example, 90 degrees) or more, the electronic device 101 may control the device to switch on a power source of the first sub-display 1050 of the sub-display unit (for example, the sub-display unit 1005-2) in an opened state. Here, an operation of switching on a power source of the display (for example, the first sub-display 1050) has been described as an operation of supplying power in an off state in which power is not supplied to the display, but the disclosure is not limited thereto and it is apparent that the disclosure is also applied to a state in which data (for example, a graphic interface) is displayed on a screen and a state in which a specific mode (for example, a sleep mode) of the display is changed into an activated state (or an activation mode). The electronic device 101 may display data displayed on the second sub-display (for example, the second sub-display 950 of FIG. 9) on the main display 150 and the first sub-display 1050. According to an example, the electronic device 101 may determine the display priorities of the first area 960 and the second area 970 based on setting information. According to an example, the electronic device 101 may determine that the first area 960 of a high display priority is displayed on the main display 150 of the electronic device 101. The electronic device 101 may display the data of the first area 960 on the main display 150 of the electronic device 101 based on the determined display priority, and may display the data of the second area 970 on the first sub-display 1050 of the sub-display unit 1005.

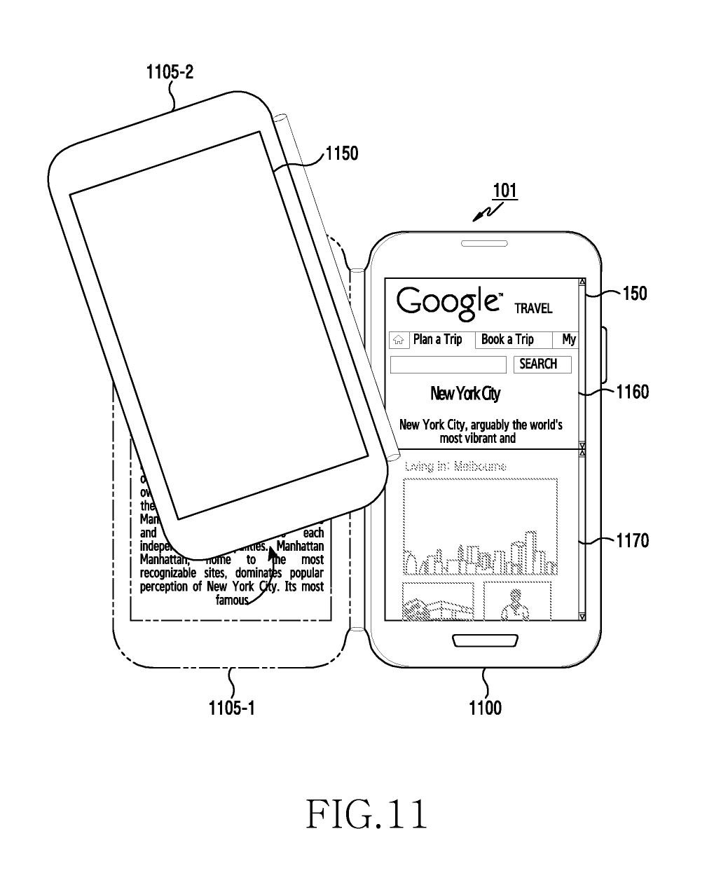

FIG. 11 is a diagram illustrating example data displayed on a display in an electronic device.

The electronic device 101 may be classified into a main display unit 1100 and a sub-display unit (for example, a sub-display 1105-1), and the sub-display unit may be a unit that may be detachably attached to (separated from or coupled to) the main display unit 1100. When the sub-display unit is attached (or coupled) to the main display unit 1100, an operation of the sub-display 1150 may be performed in association with the main display 150 of the electronic device 101 based on a method of bending (flexing) a connection part (for example, a hinge) of the main display unit 1100 and the sub-display unit 1105-1 and/or a bending method (flip or folding) as illustrated in FIG. 3.

According to various examples, the sub-display unit 1105-1 may identify an arrangement state while being attached to the main display unit 1100. According to an example, the sub-display unit may be located on a front surface (for example, a surface of the main display 150 of the main display unit 1100) of the main display unit 1100 in a facing closed state. The sub-display unit may be located in a state in which the sub-display unit is opened from a front surface (for example, a surface of the main display 150 of the main display unit 1100) of the main display unit 1100 at a designated angle (for example, more than 0 degrees and less than 360 degrees). In addition, the sub-display unit may be located on a rear surface (for example, a rear surface of the electronic device 101) of the main display unit 1100 in a backing closed state. The electronic device 101 may determine a facing closed state and an opened state of the sub-display unit with respect to the main display 150 of the main display unit 1100, or a backing closed state of the rear surface of the electronic device 101 through at least one of a proximity sensor and an illumination intensity sensor included on a front surface and/or a rear surface of the main display unit 1100, and a magnetic sensor (for example, a Hall sensor) interworking with the sub-display unit.

According to various examples, the sub-display unit 1105-1 may include at least one display (for example, a sub-display 1150), and may be a unit connected to the main display unit 1100 through a wired communication. The electronic device 101 may display data of a specific program through the sub-display 1150 of the sub-display unit 1105-1 connected to the main display unit 1100 through a wired communication. The electronic device 101 may identify that the sub-display unit 1105-1 connected to the main display unit 1100 through a wired communication is separated from the main display unit 1100 of the electronic device 101. The electronic device 101 (or a processor of the electronic device 101) may identify that the sub-display unit is separated like the sub-display unit 1105-2, and may acquire information of data that are being displayed on the sub-display of the sub-display unit 1105-1. When it is identified that a wired communication connected to the sub-display unit 1105-2 is connection-released, the electronic device 101 may display data that are being displayed on the sub-display 1105-1 on the main display 150 of the electronic device 101.

When the data that are being displayed on the sub-display of the sub-display unit 1105-1 are displayed on the main display 150, the electronic device 101 may separate a layer that is being displayed on the main display 150 (for example, into a first area 1160 and a second area 1170) to display the data of the sub-display 1150 (for example, in the first area 1160), or may generate a separate layer (for example, a popup) to display it on the main display 150.

The main display unit 1100 of the electronic device 101 may transmit an instruction for switching off the sub-display 1150 of the sub-display unit 1105-2 to the sub-display unit 1105-2 through a wireless network communication (for example, Bluetooth or Wi-Fi) or a cellular communication.

According to various examples, the sub-display unit of the electronic device 101 may include a battery, and when the sub-display unit is attached to the main display unit 1100, it may receive power from a battery of the main display unit 1100.

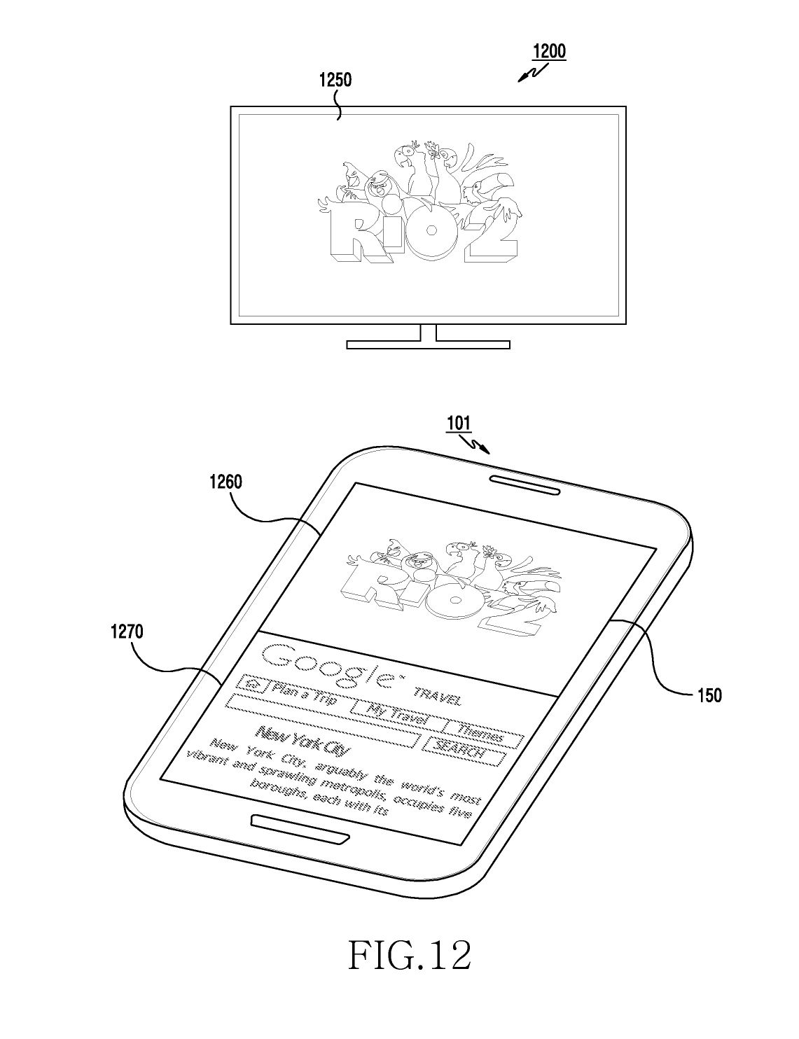

FIG. 12 is a diagram illustrating example data displayed on a display in an electronic device.

The electronic device 101 may be operated together with another electronic device (for example, an electronic device 102 or a sub-display unit 1200). Here, the electronic device 102 (for example, the sub-display unit 1200) may have the same or similar configuration as that of the electronic device 101. The sub-display unit 1200 may include at least one display (for example, a sub-display 1250). When a graphic interface (data or an image, hereinafter, data) is displayed on the sub-display 1250, the sub-display unit 1200 may display data that are controlled to be output by the processor 120 of the electronic device 101, or may display data that are controlled to be output by a processor (not illustrated) included in the sub-display unit 1200. When data are displayed on the sub-display 1250, the sub-display unit 1200 may display data included in the memory 130 of the electronic device 101, or may display data included in a memory (not illustrated) of the sub-display unit 1200.

According to various examples, when data are displayed on the sub-display 1250 under the control of the processor 120 of the electronic device 101, the sub-display unit 1200 may receive data through at least one communication interface connected to the electronic device 101, or may display the received data on the sub-display 1250. According to an example, the sub-display unit 1200 may receive data from the electronic device 101 through a communication interface such as a short-range wireless communication connected to the electronic device 101, a cellular communication, and/or a wired communication. For example, the sub-display unit 1200 may receive data from the electronic device 101 connected using at least one short-range wireless communication method of a Wi-Fi communication, a Bluetooth (BT) communication, a Near Field Communication (NFC) communication, a Near Field Magnetic Induction (NFMI) communication, and a Frequency Modulation (FM) communication. According to an example, the sub-display unit 1200 may receive data from the electronic device 101 using at least one connected communication method of cellular communications (for example, LTE, LTE-A, WCDMA, UMTS, WiBro, and GSM). According to an example, when the electronic device 102 is mounted (or attached) to the electronic device 101, it may receive data from the electronic device 101 through at least one wired communication method of a Universal Serial Bus (USB), a High Definition Multimedia Interface (HDMI), Recommended Standard 232 (RS-232), and a Plain Old Telephone Service (POTS).

According to various examples, the electronic device 101 may display data displayed on the sub-display 1250 of the electronic device 102 on the main display 150 of the electronic device 101. According to an example, the electronic device 101 may control the arrangement such that data (for example, a video that is being reproduced) of a specific program are displayed on the sub-display 1250 of the electronic device 102. When a video is displayed on the sub-display 1250, the electronic device 101 may transmit data through a short-range wireless communication connected to the electronic device 102. The electronic device 101 may determine that a short-range wireless communication connected to the electronic device 102 is connection-released while a video is being reproduced through the sub-display 1250. Alternatively, the electronic device 101 may identify that a power source of the sub-display 1250 is switched off while a video is being reproduced through the sub-display 1250. When it is identified that a short-range wireless communication connected to the electronic device 102 is connection-released or a power source of the sub-display 1250 is switched off, the electronic device 101 may identify data corresponding to a corresponding time point. The electronic device 101 may reproduce a video on the main display 150 of the electronic device 101 that displays data (for example, an Internet page) of a specific program from a corresponding time point based on the identified data. For example, when a video displayed on the sub-display 1250 is displayed on the main display 150, the electronic device 101 may display the video in the determined first area 1260 based on the screen ratio of the main display 150. When the first area 1260 is determined, the electronic device 101 may divide at least a part of a layer 1270 that is displaying an Internet page of the main display 150, or generate and display a layer separate from the layer 1270 that is displaying an Internet page.

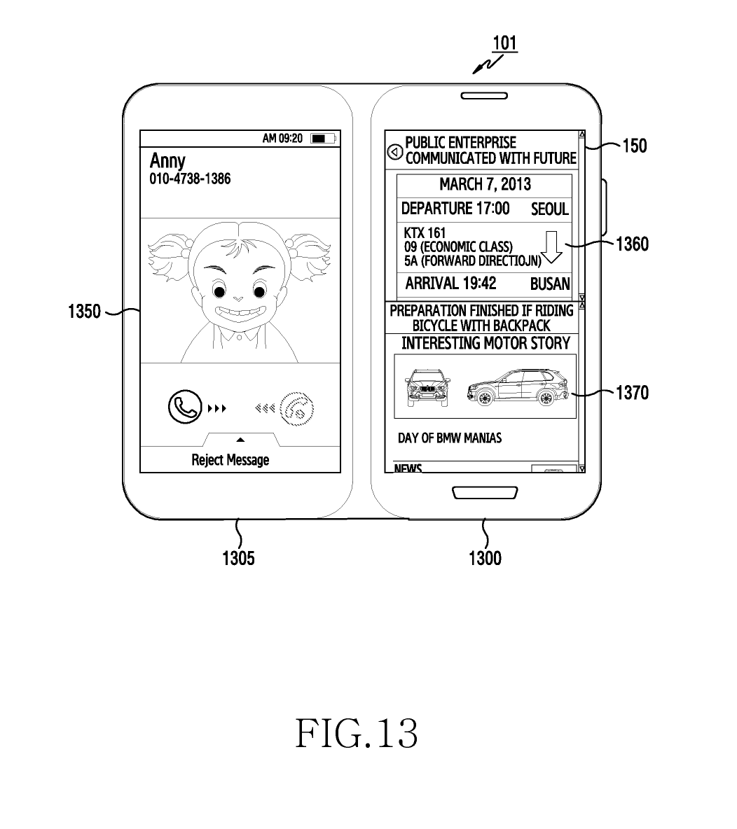

FIG. 13 is a diagram illustrating example data displayed on a display in an electronic device.

According to various examples, the electronic device 101 may perform a call receiving operation while displaying data of specific programs through the main display 150 and the sub-display 1350 of the sub-display unit 1305. According to an example, the electronic device 101 may display (for example, see the main display 150 of FIG. 4) an Internet page on the main display 150, and may display (for example, see the sub-display 450 of FIG. 4) an Internet page for identifying ticketing of a ticket of a train on the sub-display 1350 of the sub-display unit 1305. The electronic device 101 may receive a call from another electronic device (for example, the electronic device 103) while data of a specific program are displayed on the main display 150 and the sub-display 1350, and may display information on the corresponding call reception on a display. The electronic device 101 may display an Internet page for identifying ticketing of a ticket of a train that is being displayed on the sub-display 1350 on the main display 150, and may display information on the call reception on the sub-display 1350.

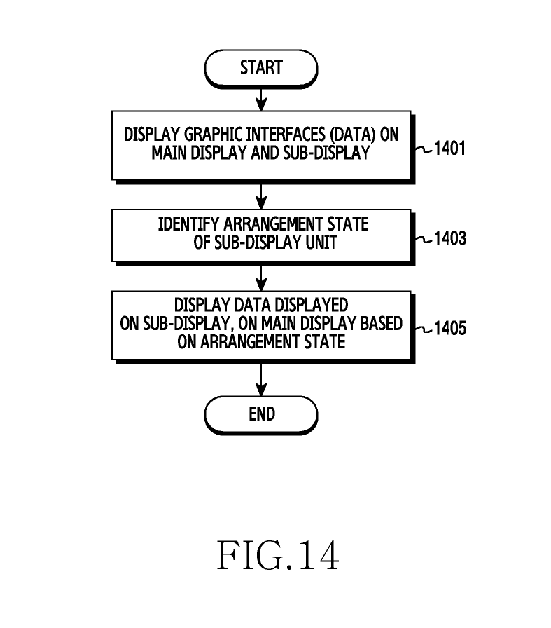

FIG. 14 is a flowchart illustrating an example operation in which data are displayed on a display in an electronic device.

Referring to operation 1401, the electronic device 101 may display graphic interfaces (for example, data) of specific programs on the main display of the main display unit and the first sub-display of the sub-display unit. Here, the sub-display unit may include at least one display (for example, a first sub-display), and may be attached to or detached from the electronic device 101. When the sub-display unit is attached to the electronic device, it may transmit and receive data to and from the electronic device 101 through a wired communication, and when the sub-display unit is separated from the electronic device, it may transmit and receive data to and from the electronic device 101 through a short-range wireless communication.

Referring to operation 1403, the electronic device 101 may identify an arrangement state of the sub-display unit. According to an example, the electronic device 101 may identify a closed state (for example, a facing closed state or a backing closed state) in which the sub-display unit is attached to the electronic device 101 through at least one sensor (for example, a proximity sensor, an illumination intensity sensor, or an infrared ray sensor) included on a front surface or a rear surface of the main display unit.

According to various examples, the electronic device 101 may not only identify an arrangement state such as a closed state or an opened state of the sub-display unit but also identify a detached or coupled state (a separated or coupled state) of the sub-display unit when the sub-display unit is attached to or detached from the main display unit of the electronic device 101. In an operation of identifying that the sub-display unit is separated, the electronic device 101 may identify that the sub-display unit is separated based on the connection-release of a wired communication connected to the sub-display unit. In addition, the electronic device 101 may not only identify that the sub-display unit is separated, but also identify a power source of at least one display (for example, a first sub-display) included in the sub-display unit is switched off.

Referring to operation 1405, when an arrangement state (and at least one operation of separation of the sub-display unit, connection-release of a wired communication, and switching off of a power source of the first sub-display) of the sub-display unit is identified, the electronic device 101 may display data that are being displayed on the first sub-display through the main display of the electronic device 101. According to an example, when the data that are being displayed on the first sub-display are displayed on the main display of the electronic device 101, the electronic device 101 may divide and display a layer that is being displayed on the main display, or may generate and display a layer that is separate from the layer that is being displayed on the main display.

The electronic device 101 may end the example of FIG. 14 after performing operation 1405.

According to various examples, an operation method of the electronic device may include an operation of determining an arrangement state of the main display unit and the sub-display unit, and an operation of controlling at least one display location of the data displayed on the main display of the electronic device and the data displayed on the first sub-display based on the arrangement state. According to an example, an operation of determining an arrangement state of the sub-display unit may include an operation of determining folding/unfolding of the sub-display unit attached to the electronic device. According to an example, an operation of determining folding/unfolding of the sub-display unit may include an operation of identifying folding/unfolding of the sub-display unit using at least one of a proximity sensor, an infrared ray sensor, and an illumination intensity sensor included in the electronic device, and a magnetic sensor (for example, a Hall sensor) connected to the second electronic device. According to an example, an operation of controlling at least one display location of the displayed data may include an operation of displaying the data displayed on the first sub-display of the sub-display unit on the main display of the electronic device. According to an example, an operation of controlling at least one display location of the displayed data may further include an operation of displaying the data displayed on the main display and the first sub-display of the electronic device on the second sub-display. According to an example, an operation of determining folding/unfolding of the sub-display unit may further include an operation of separating the sub-display unit attached to the electronic device. According to an example, an operation of determining folding/unfolding of the sub-display unit may further include an operation of connection-releasing a wired communication connected to the sub-display unit. According to an example, an operation of determining folding/unfolding of the sub-display unit may further include an operation of connecting the sub-display unit through a short-range wireless communication. According to an example, the method may further include an operation of identifying at least one battery state information element of battery state information included in the main display unit of the electronic device and battery state information of a battery included in the sub-display unit, and an operation of controlling at least one display location of the displayed data may further include an operation of performing the control operation when the at least one battery state information element satisfies a reference condition.

According to various examples, the operation method of the electronic device may include an operation of detecting an arrangement state of the main display unit or the sub-display unit, and an operation of controlling display of the data that are being displayed on the main display included in the main display unit and/or the sub-display included in the sub-display unit based on the detected arrangement state.

According to an example, the arrangement state may represent an opened state or a backing closed state of the main display unit and the sub-display unit. According to an example, an opened state may be a state in which data of different programs or different data of the same program are displayed on the main display and/or the sub-display. According to an example, in a closed state, the data displayed on the main display and/or the sub-display may be displayed on the main display and/or the sub-display. According to an example, a closed state may include a first closed state in which the main display unit and the sub-display unit are closed in a facing state and a second closed state in which the main display unit and the sub-display unit are closed in a backing state. According to an example, the second closed state may be a state in which at least some of the data displayed on the sub-display are displayed on the main display. According to an example, the second closed state may be a state in which the screen of the main display and the screen of the sub-display are configured at a preset ratio such that data are displayed on the main display. According to an example, the facing closed state may be a state in which the first sub-display included on a first surface of the sub-display unit faces the main display, and the backing closed state may be a state in which the second sub-display included on a second surface of the sub-display unit faces the main display unit. According to an example, the facing closed state may be a state in which at least some of the data displayed on the main display and the first sub-display are displayed on the second sub-display. According to an example, the sub-display of the sub-display unit may receive power from a battery of the main display unit electrically connected to the sub-display unit. According to an example, the sub-display is driven by power of the battery included in the sub-display unit, and may receive display data from the main display through a communication interface connected to the main display unit. According to an example, at least one sensor may include at least one of a proximity sensor, an infrared ray sensor, an illumination intensity sensor, and a Hall sensor.

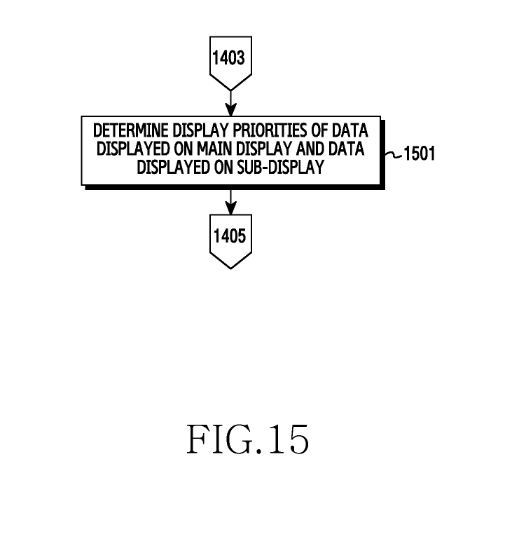

FIG. 15 is a flowchart illustrating an example operation in which data are displayed on a display in an electronic device.

Referring to operation 1501, when data of a first specific program that are being displayed on the sub-display of the sub-display unit are displayed on the main display of the electronic device 101, the electronic device 101 may determine the display priorities of the specific programs based on the data of the first specific program that are being displayed on the main display and the data of the second specific program that are being displayed on the sub-display. When the display priorities are determined, the electronic device 101 may determine a program corresponding to the data displayed finally as a highest priority based on a user input. According to an example, the electronic device 101 may determine a program having the largest amount of processing as the highest priority based on the amount of processed data. According to an example, the electronic device 101 may determine a program having the largest accumulated use times as the highest priority.

According to an example, operation 1501 of the electronic device 101 may be an operation performed after operation 1403 of FIG. 14. When the electronic device 101 performs operation 1501, it may perform operation 1405 of FIG. 14, or may end the example of FIG. 15.

According to an example, when the electronic device 101 performs operation 1405 of FIG. 14, it may control display of data that are being displayed on the main display and data that are being displayed on the sub-display based on the determined priority. According to an example, the electronic device 101 may display data of a program having a high priority according to the determined priority in an area (or layer) of a large size set to the main display.

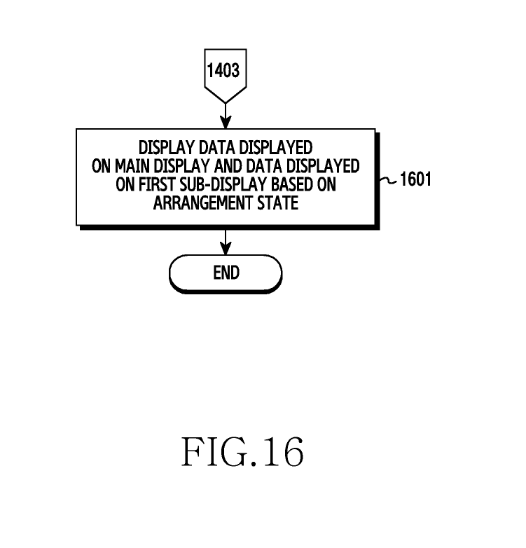

FIG. 16 is a flowchart illustrating an example operation in which data are displayed on a display in an electronic device.

Referring to operation 1601, the electronic device 101 may display data of a program that are being displayed on the main display of the electronic device 101 and data of a program that are being displayed on the first sub-display of the sub-display unit on the second sub-display of the sub-display unit based on the identified folding operation. According to an example, the electronic device 101 may identify a facing closed state in which the sub-display unit is attached to a front surface of the electronic device 101 through operation 1403 of FIG. 14. For example, the electronic device 101 may identify a state in which the sub-display unit is closed to a front surface of the electronic device 101 through at least one sensor included on a front surface thereof or through a magnetic sensor (for example, a Hall sensor) connected to the sub-display unit.

According to an example, the sub-display unit may include two or more displays (for example, the first sub-display and the second sub-display). When the sub-display unit is closed to a front surface of the electronic device 101, the main display of the electronic device 101 and the first sub-display of the sub-display unit may face each other. The electronic device 101 may display data that are being displayed on the main display and data that are being displayed on the second electronic device on the second sub-display of the sub-display unit.

According to an example, operation 1601 may be an operation performed after operation 1403 of FIG. 14, and when the electronic device 101 performs operation 1601, it may end the example of FIG. 16.

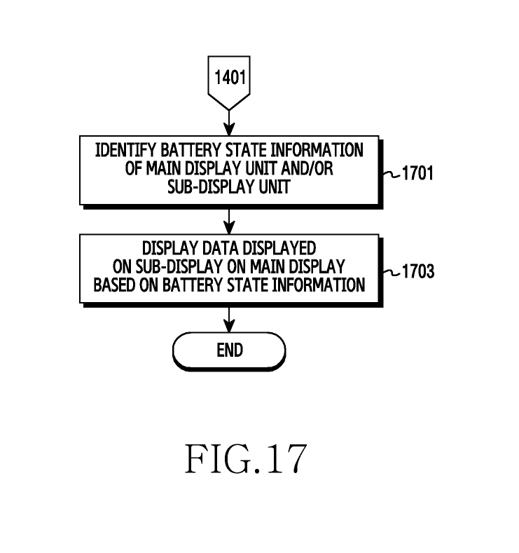

FIG. 17 is a flowchart illustrating an example operation in which data are displayed on a display in an electronic device.

According to an example, operation 1701 may be an operation performed after operation 1401 of FIG. 14. Referring to operation 1701, the electronic device 101 may acquire battery state information of the main display unit and/or the sub-display unit. According to an example, the electronic device 101 may acquire battery level information of the main display unit and/or the sub-display unit, and may acquire information on an amount of use of the battery of the display (for example, the main display) included in the electronic device 101 and/or the display (for example, the first sub-display and/or the second sub-display) included in the sub-display unit. When the electronic device 101 acquires battery state information of the sub-display unit, it may receive the battery state information acquired by the sub-display unit.

Referring to operation 1703, the electronic device 101 may control at least one of the main display unit and/or the sub-display unit based on the acquired battery state information. According to an example, when the battery level of the sub-display unit is lowered to below a designated value, the electronic device 101 may switch off a power source of the first sub-display. The electronic device 101 may display data that are being displayed on the first sub-display on the main display of the electronic device 101.

According to various examples, when the battery level of the electronic device 101 is lowered to below a designated value, the electronic device 101 may switch off a power source of the main display. The electronic device 101 may display data that are being displayed on the main display and data that are being displayed on the first sub-display of the sub-display unit on the second sub-display of the sub-display unit. According to an example, the second sub-display of the sub-display unit may be operated in a low power mode.

Upon completing operation 1703, the electronic device 101 may end the example of the disclosure shown in FIG. 17.

According to various examples, it has been described that the electronic device 101 determines a folding/unfolding operation, connection of at least one communication method, and a condition of battery state information when the data displayed through at least one display are controlled, but the disclosure is not limited thereto and it is apparent that an operation of displaying data on the display may be controlled by combining two or more conditions.

Various examples performed by the electronic device 101 may be operations performed by a control of the processor 120. The electronic device 101 may include a module, separate from the processor 120, which is programmed to control the various examples of the disclosure. The separate module programmed to control the various examples of the disclosure may operate under a control of the processor 120.

According to various examples, the processor 120 may determine an arrangement state of the sub-display unit, and control a display location of at least one of data displayed on a main display of the electronic device and data displayed on the first sub-display based on the arrangement state. The processor 120 may determine an arrangement state of the sub-display unit. The processor 120 may determine an arrangement state of the sub-display unit using at least one of a proximity sensor, an infrared ray sensor, an illumination intensity sensor, and a magnetic sensor (for example, a Hall sensor) included in the main display unit. The processor 120 may display the data displayed on the first sub-display on the main display. The processor 120 may display the data displayed on the main display and the first sub-display on the second sub-display. The processor 120 may determine an arrangement state of the sub-display unit as a state in which the sub-display unit attached to the main display unit of the electronic device 101 is separated. The processor 120 may determine an arrangement state of the sub-display unit as a state in which a wired communication connected to the sub-display unit is connection-released. When the wired connection connected to the sub-display unit is connection-released, the processor 120 may be connected to the sub-display unit through a short-range wireless communication. The processor 120 may identify at least one battery state information element of battery state information included in the main display unit and battery state information included in the sub-display unit, and control a display location of at least one of the displayed data when the at least one battery state information element satisfies a reference condition.

An electronic device according to various examples may include a main display unit or apparatus including a main display, a sub-display unit or apparatus including at least one sub-display and functionally connected to the main display, at least one sensor that detects an arrangement state of the main display unit and/or the sub-display unit, and a processor that is configured to control display of data that are being displayed on the main display and/or the sub-display based on the detected arrangement state.

According to an example, the arrangement state may represent an opened state or a closed state of the main display unit and the sub-display unit. According to an example, in an opened state, the processor may display data of different programs or different data of the same program on the main display and/or the sub-display. According to an example, in a closed state, the processor may display the data displayed on the main display and/or the sub-display on the main display and/or the sub-display. According to an example, a closed state may represent a first closed state in which the main display unit and the sub-display unit are closed in a facing state and a second closed state in which the main display unit and the sub-display unit are closed in a backing state. According to an example, in the second closed state, the processor may display at least some of the data displayed on the sub-display on the main display. According to an example, in the second closed state, the processor may configure the screen of the main display and the screen of the sub-display at a preset ratio such that data are displayed on the main display. According to an example, the sub-display included in the sub-display unit includes a first sub-display mounted on a first surface of the sub-display unit and a second display mounted on a second surface, and here, the first surface may be a surface facing the main display while the first sub-display is in a facing closed state and the second surface may a surface facing the main display unit while the second sub-display is in a backing closed state. According to an example, in the first closed state, the processor may display at least some of the data displayed on the main display and the first sub-display on the second sub-display. According to an example, the main display unit and the sub-display unit are electrically connected to each other, and the sub-display of the sub-display unit may receive power from a battery of the main display unit. According to an example, the sub-display unit further includes a battery and a communication interface, and the sub-display is driven by power of the battery and may receive display data from the main display unit through the communication interface. According to an example, the at least one sensor may include at least one of a proximity sensor, an infrared ray sensor, an illumination intensity sensor, and a Hall sensor.

Each of the above described elements of the electronic device according to various examples of the disclosure may include one or more components, and the name of a corresponding element may vary according to the type of electronic device. The electronic device according to various examples of the disclosure may include at least one of the above described elements and may exclude some of the elements or further include other additional elements. Further, some of the elements of the electronic device according to various examples of the disclosure may be coupled to form a single entity while performing the same functions as those of the corresponding elements before the coupling.

According to various examples of the disclosure, at least some of the devices or methods according to various examples of the disclosure as defined by the appended claims and/or disclosed herein may be implemented in the form of hardware, software, firm ware, or any combination (e.g., module or unit) of at least two of hardware, software, and firmware. The “module” may be interchangeable with a term, such as a unit, a logic, a logical block, a component, or a circuit. The “module” may be a minimum unit of an integrated component element or a part thereof. The “module” may be the smallest unit that performs one or more functions or a part thereof. The “module” may be mechanically or electronically implemented. For example, the “module” according to the disclosure may include at least one of an Application-Specific Integrated Circuit (ASIC) chip, a Field-Programmable Gate Arrays (FPGA), and a programmable-logic device for performing operations which has been known or are to be developed hereinafter. If implemented in software, a computer-readable storage medium (or storage medium readable by a computer) storing at least one program (or programming module) may be provided. The software may, for example, be implemented by instructions stored in a computer-readable storage medium in the form of a programming module. The at least one program may include instructions that cause the electronic device to perform the methods according to various examples of the disclosure as defined by the appended claims and/or disclosed herein. When the command is executed by one or more processors (for example, the processor 120), the one or more processors may execute a function corresponding to the command. The computer-readable storage medium may, for example, be the memory 230. At least a part of the programming module may, for example, be implemented (e.g., executed) by the processor 220. At least a part of the programming module may, for example, include a module, a program, a routine, a set of instructions, or a process for performing at least one function.

According to various examples, the electronic device may include a computer readable storage medium in which a program for performing an operation of determining an arrangement state of a sub-display unit and an operation of controlling a display location of at least one of data displayed on the main display and data displayed on the sub-display is stored.

The computer-readable storage medium may include magnetic media such as a hard disc, a floppy disc, and a magnetic tape; optical media such as a compact disc read only memory (CD-ROM) and a digital versatile disc (DVD); magneto-optical media such as a floptical disk; a hardware device specifically configured to store and execute program instructions (e.g., programming module), such as a read only memory (ROM), a random access memory (RAM), and a flash memory; an electrically erasable programmable read only memory (EEPROM); a magnetic disc storage device; any other type of optical storage device; and a magnetic cassette. Alternatively, any combination of some or all of the may form a memory in which the program is stored. Further, a plurality of such memories may be included in the electronic device. In addition, the program instructions may include high class language codes, which can be executed in a computer by using an interpreter, as well as machine codes made by a compiler.

In addition, the program may be stored in an attachable storage device capable of accessing the electronic device through a communication network such as the Internet, an intranet, a local area network (LAN), a wide LAN (WLAN), a storage area network (SAN), or any combination thereof. The storage devices may be connected to an electronic device through an external port. Further, a separate storage device on the communication network may access a portable electronic device. Any of the hardware devices as described above may be configured to work as one or more software modules in order to perform the operations according to various examples of the disclosure, and vice versa.

Any of the modules or programming modules according to various examples of the disclosure may include at least one of the above described elements, exclude some of the elements, or further include other additional elements. The operations performed by the modules, programming module, or other elements according to various examples of the disclosure may be executed in a sequential, parallel, repetitive, or heuristic manner. Further, some operations may be executed according to another order or may be omitted, or other operations may be added.

The examples of the disclosure disclosed herein and shown in the drawings are merely examples presented in order to easily describe technical details of the disclosure and to help the understanding of the disclosure, and are not intended to limit the scope of the disclosure. Therefore, it should be understood that, in addition to the examples disclosed herein, all modifications and changes or modified and changed forms derived from the technical idea of the disclosure fall within the scope of the disclosure.

What is claimed is:

1. An electronic device comprising:
a main display apparatus comprising a main display;
a sub-display apparatus comprising at least one sub-display and functionally connected to the main display;
at least one sensor configured to detect an arrangement state of the main display apparatus and the sub-display apparatus; and
at least one processor configured to control display of data that are being displayed on the main display or the sub-display based on the detected arrangement state.

2. The electronic device of claim 1, wherein the arrangement state comprises at least one of an opened state or a backing closed state of the main display apparatus and the sub-display apparatus.

3. The electronic device of claim 2, wherein in the opened state, the processor is configured to display data of different programs on the main display or the sub-display, or display different data of the same program.

4. The electronic device of claim 2, wherein in the backing closed state, the processor is configured to display data displayed on the main display or the sub-display on the main display.

5. The electronic device of claim 2, wherein in the backing closed state, the processor is configured to display at least some of the data displayed on the sub-display on the main display.

6. The electronic device of claim 2, wherein in the backing closed state, the processor is configured to configure a screen of the main display and a screen of the sub-display at a preset ratio and display the configured screen on the main display.

7. The electronic device of claim 2, wherein the arrangement state further comprises a facing closed state.

8. The electronic device of claim 7, wherein the sub-display included in the sub-display apparatus comprises a first sub-display mounted on a first surface of the sub-display apparatus and a second sub-display mounted on a second surface of the sub-display apparatus,
wherein the first surface is a surface facing the main display while the first sub-display is in a facing closed state, and the second surface is a surface facing the main display apparatus while the second sub-display is in a backing closed state.

9. The electronic device of claim 8, wherein in the facing closed state, the processor is configured to display at least some of data displayed on the main display and the first sub-display on the second sub-display.

10. The electronic device of claim 1, wherein the main display apparatus and the sub-display apparatus are electrically connected to each other, and the sub-display of the sub-display apparatus is configured to receive power from a battery of the main display apparatus.

11. The electronic device of claim 1, wherein the sub-display apparatus further comprises:
a battery; and
a communication interface, and
wherein the sub-display is configured to operate under power of the battery and receive display data from the main display unit through the communication interface.

12. The electronic device of claim 1, wherein the at least one sensor comprises at least one of a proximity sensor, an infrared ray sensor, an illumination intensity sensor, a Hall sensor, and a bending sensor.

13. A method of operating an electronic device, comprising:
detecting an arrangement state of a main display unit and a sub-display unit; and
controlling display of data that are being displayed on a main display included in the main display unit or a sub-display included in the sub-display unit based on the detected arrangement state.

14. The method of claim 13, wherein the arrangement state is an opened state or a backing closed state of the main display unit and the sub-display unit.

15. The method of claim 14, wherein controlling display of data comprises displaying different data of the same program or displaying data of different programs on the main display or the sub-display when the arrangement state is the opened state.

16. The method of claim 14, wherein controlling display of data comprises displaying data displayed on the main display or the sub-display on the main display when the arrangement state is the backing closed state.

17. The method of claim 14, wherein controlling display of data comprises displaying at least some of the data displayed on the sub-display on the main display when the arrangement state is the backing closed state.

18. The method of claim 14, wherein controlling display of data comprises configuring a screen of the main display or a screen of the sub-display at a preset ratio and displaying the configured screen on the main display when the arrangement state is the backing closed state.

19. The method of claim 14, wherein the arrangement state further comprises a facing closed state.

20. The method of claim 19, wherein the first surface of the sub-display unit is a surface that faces the main display while the first sub-display included on the first surface is in a facing closed state, and a second surface of the sub-display unit is a surface in which a second sub-display included in the second surface faces the main display unit.

21. The method of claim 20, wherein controlling display of data comprises displaying at least some of data displayed the main display or the sub-display on the second sub-display when the arrangement state is the facing closed state.

22. The method of claim 13, wherein the sub-display of the sub-display unit receives power from a battery of the main display unit electrically connected to the sub-display unit.

23. The method of claim 13, wherein the sub-display is driven by power of the battery included in the sub-display unit, and receives display data from the main display unit through a communication interface connected to the main display unit.

24. The method of claim 13, wherein the at least one sensor comprises at least one of a proximity sensor, an infrared ray sensor, an illumination intensity sensor, a Hall sensor, and a bending sensor.
